(19) United States
(12) Patent Application Publication
(10) Pub. No.: US 2020/0042021 A1
(43) Pub. Date: Feb. 6, 2020

(54) Systems And Methods For Calibrating And Tuning A Mass Flow Controller

(71) Applicant: Bhushan Somani, Yorba Linda, CA (US)

(72) Inventor: Bhushan Somani, Yorba Linda, CA (US)

(21) Appl. No.: 16/597,781

(22) Filed: Oct. 9, 2019

Related U.S. Application Data
(63) Continuation-in-part of application No. 15/907,138, filed on Feb. 27, 2018.
(60) Provisional application No. 62/464,251, filed on Feb. 27, 2017.

(51) Int. Cl. G05D 7/06; G01M 3/28; F16K 37/00

(52) U.S. Cl. CPC G05D 7/0635; F16K 37/005; G01M 3/2876

(57) ABSTRACT

A mass flow control apparatus and methods for calibrating and tuning the mass flow apparatus are provided. The mass flow apparatus can be calibrated by receiving a calibration input signal that provides one or more properties of a gas that is flowing through a main fluid flow path and performing one or more measurements, using one or more sensors, on the gas. The calibration includes determining a calibration parameter based on the results of the one or more measurements and the calibration input signal and adjusting a proportional valve, based on the calibration parameter, to adjust a flow rate, of the gas through the apparatus, to match a setpoint flow rate.

### PRIORITY CLAIM TO RELATED APPLICATIONS

This application is a continuation-in-part of Non-Provisional application Ser. No. 15/907,138, filed Feb. 27, 2018, entitled as “Systems and Methods for Flow Sensor Back Pressure Adjustment for Mass Flow Controller”, which claimed the benefit of U.S. Provisional Patent Application No. 62/464,251, filed Feb. 27, 2017, entitled as “Systems, Apparatus and Methods for Flow Sensor Back Pressure Adjustment for Mass Flow Control”, each of which is incorporated herein by reference in its entirety.

### BACKGROUND

Mass flow controllers control the flow rate of a gas or liquid that flows through the mass flow controller. Controlling the flow rate of a gas can be challenging because the flow rate measurement is dependent on properties of the gas such as temperature, pressure and volume. Those properties inevitably change as the flow of the gas is restricted as the gas moves through the mass flow controller. To produce accurate measurements, a calibration is typically done under factory conditions for the various types of gases that the mass flow controller is likely to receive.

Mass flow controllers are also typically tuned under factory conditions. The tuning of a mass flow controller determines how the mass flow controller adjusts a proportional valve to match the measured flow rate to a setpoint flow rate. An overly aggressive tuning may cause the mass flow controller to adjust the proportional valve too quickly and overshoot the setpoint flow rate. Different types and compositions of gases may require different tuning parameters. A change in tuning may be required when the mass flow controller is away from factory conditions. There is a need for a mass flow controller that can be calibrated and tuned in the field. There is also a need for a mass flow controller that can be easily configured in the field and can easily transmit data to users.

Various embodiments relate to mass flow control apparatus. Mass flow controller may operate by modulating a fluid pressure. Fluid as used herein is intended to encompass materials which are in a gaseous phase because of specific combinations of pressure and temperature despite whether such materials are gaseous under everyday circumstances. Thus, fluids may include water vapor or boron trichloride (BCl3), for example, along with common gaseous materials such as silane (SiH4), argon, nitrogen, etc. The embodiments described below relate to determining the present flow conditions at a flow restriction in a fluid flow pathway to ascertain whether or not a chosen flow control algorithm is valid for those present conditions. At various times, a low fluid flow rate may be required while a silicon manufacturing chamber may also provide back pressure. Providing a low fluid flow rate in a backpressure environment may be challenging. Various embodiments described below are directed to addressing issues related to low flow conditions with back pressure from the upstream direction.

### SUMMARY

The present disclosure includes methods for calibrating a mass flow controller. In an exemplary embodiment, a method includes receiving a calibration input signal that provides one or more properties of a gas that is flowing through a main fluid flow path. The method includes performing one or more measurements, using one or more sensors, on the gas and determining a calibration parameter based on the results of the one or more measurements and the calibration input signal. The method includes adjusting a proportional valve, based on the calibration parameter, to adjust a flow rate, of the gas through the apparatus, to match a setpoint flow rate. The one or more measurements of the method may be one or more rate of decay measurements. The method may further include determining a measured volume based on the results of the one or more rate of decay measurements where the calibration input signal provides an actual volume of the gas and where the calibration parameter matches the measured volume to the actual volume. The shut-off valve may include an elastomer located between a shut off valve seat and shut off valve body components. The method may further include performing a subsequent rate of decay measurement, responsive to receiving a command, based on the calibration parameter. The method may further include determining a leak-by value based on the subsequent rate of decay measurement. The setpoint flow rate of the method may be received by a wireless antenna.

In an exemplary embodiment, a mass flow control apparatus may include a main fluid flow path connected to a proportional valve and at least one sensor that measures a property of a gas in the flow path downstream to a flow restrictor. The apparatus includes a control module configured to receive a calibration input for a gas and calculate a rate of decay from a signal from the at least one sensor when the inlet valve is closed where the control module is further configured to calculate a calibration parameter based on the rate of decay and receive a setpoint flow rate. The control module is further configured to adjust the proportional valve, based on the calibration parameter, to adjust a flow rate, of the gas through the apparatus, to match the setpoint flow rate. The calibration input of the mass flow control apparatus may be an actual volume of the gas where the calibration parameter matches a measured volume, based on the rate of decay, to the actual volume of the gas. The calibration input of the mass flow control apparatus may be one or more values for actual flow performance where each of the one or more values for actual flow performance is given for a configuration point that is on the flow spectrum for the apparatus and the calibration parameter determines a measured flow rate, based on the rate of decay, and matches the measured flow rate to each of the one or more values for actual flow performance. The control module may be further configured to detect a deviation of accuracy based on the calibration parameter and set off an alarm to alert the user of the deviation where the alarm is further configured to transmit an alarm signal over a communication protocol. The mass flow control apparatus may further include an elastomer located between the shut off valve seat and shut off valve body components. The elastomer may be a corrosion resistant material selected from the group consisting of PCTFE, PTEE, TEFLON, or NYLON. The control module of the mass flow control apparatus may be further configured to calculate a leak-by value based on the rate of decay. The mass flow apparatus may further include a wireless antenna that can receive signals and transmit signals.

Another general aspect is a method for tuning a mass flow control apparatus. The method includes providing a main fluid flow path connected to a proportional valve, an inlet valve connected to the main flow path, a shut off valve located downstream from the inlet valve and connected to the main flow path. The method includes receiving an input signal for a gas that is flowing through the main fluid flow path and adjusting the proportional valve, based on the input signal. The method includes determining a response to the flow rate after the adjustment of the proportional valve and determining a tuning parameter based on the response. The input signal may be received at one or more configuration points on the flow spectrum of the mass flow control apparatus. The input signal may be received by a wireless antenna. The shut-off valve may include an elastomer material at the seal of a valve seat and a valve body component. The method may further include performing a rate of decay measurement, responsive to receiving a command and determining a leak-by value based on the subsequent rate of decay measurement.

In consideration of the foregoing applicant has invented a fluid mass flow control apparatus comprising three valves, a flow restriction, and provisions for determining three different fluid pressures and at least one temperature.

In accordance with one embodiment, a mass flow control apparatus is provided that includes a control module configured to receive a first set point for delivering a fluid delivery to a tool, responsive to the control module receiving a second set point that is significantly lower than a first set point, a variable control valve located downstream from the flow restrictor and downstream from a first pressure sensor configured to constrict to reduce the flow of the fluid responsive to receiving the second set point. The mass flow controller apparatus further including solenoid type valve as a variable control valve. The variable control valve is configured to control the downstream pressure from the flow restrictor. A second pressure sensor located upstream from the variable control valve, the second pressure sensor configured to measure back pressure from the tool. The variable control valve constricts sufficiently to increase the pressure of the fluid from the flow restrictor to be higher than the measured back pressure from the tool and adjust the pressure to the flow restrictor such that the pressure drops across the flow restrictor to yield a flow rate that is equal to the second set point. A proportional control valve that is a solenoid valve to control the pressure to the flow restrictor and a shutoff valve including a solenoid valve to close the inlet supply to perform a rate of decay measurement operation.

In another embodiment, a mass flow control apparatus is provided that includes a proportional valve upstream of a flow measurement portion, a pressure sensing element fluidly connected to determine a fluid pressure, downstream of the flow measurement portion and a dynamically adjustable variable valve downstream of both the flow measurement portion and the pressure sensing element connection. A solenoid valve to control pressure to a flow restrictor with a proportional control valve that is a solenoid valve to control the pressure to the flow restrictor. A shutoff valve comprises a solenoid valve to close the inlet supply to perform a rate of decay measurement operation. A pressure-based flow sensor including a fluid conduit with fluidly coupled pressure and temperature sensing provisions upstream of a known flow restriction. A thermal-based flow sensor includes fluid conduit with two spaced apart temperature responsive elements affixed to the exterior of the fluid conduit. The dynamically adjustable variable valve can be adjusted to any of at least two different amounts of openings. The dynamically adjustable variable valve can be continuously adjusted to a range of openings.

In various embodiments, a mass flow control apparatus is provided that includes an inlet to a fluid pathway, a controllable shutoff valve, the controllable shutoff valve providing provisions for measuring a reference temperature (T0) and a reference pressure (P0) of a fluid contained within a reference volume of the fluid pathway, a proportional control valve, the proportional control valve providing provisions for measuring a first temperature (Ti) and a first pressure (P1) of the fluid contained within the fluid pathway upstream of a flow restriction, the flow restriction providing provision for measuring a second pressure (P2) of the fluid contained within the fluid pathway downstream of the flow restriction, a variable valve; and an outlet from the fluid pathway. The flow restriction is chosen from group of an orifice, a nozzle, a porous sintered metal element or a laminar flow structures. A supervision function may choose an action from group of self-calibration process, change of system parameter or storage of results.

In various embodiments, a method for a mass flow control apparatus is provided, including determining a fluid pressure downstream of a flow sensor, responding to the fluid pressure downstream and adjusting dynamically a variable valve downstream of the flow sensor to maintain desired operating conditions in the flow sensor; and maintaining and extending the useful operating range of the mass flow control apparatus. The method further including a flow verification capability. The flow verification capability including the steps of closing a shutoff valve to isolate a fluid pathway from an inlet while controlled mass flow continues through an outlet; making repeated measurements of a reference volume of a fluid pathway for a period of time, opening the shutoff valve to re-establish fluid pathway connection to the inlet, calculating a verified flow signal using pressure-volume-temperature methods; and providing a verified flow signal to a supervision function. The supervision function directs that a series of flow verification measurements be performed corresponding to different values of determined fluid pressures and fluid temperatures adjacent the flow restriction and determines a calibration curve for a discrete flow restriction based on the flow signals generated by the flow verification measurements.

A mass flow control apparatus including a control module configured to receive a first set point flow rate for delivering a fluid delivery to a tool, responsive to the control module receiving a second set point that is significantly lower that a first set point flow rate: a variable control valve located downstream from a flow restrictor and downstream from a first pressure sensor, the variable control valve configured to constrict to adjust the pressure of the fluid responsive to receiving the second set point flow rate; and a proportional control valve located upstream from the flow restrictor to adjust the pressure to the flow restrictor. In some embodiments the variable control valve is a solenoid type valve. In various embodiments, the proportional control valve is a solenoid type valve. In various embodiments, the variable control valve is configured to control the pressure downstream from the flow restrictor responsive to receiving a significantly lower second set point; and wherein significantly lower is 5% of full scale fluid flow rate. In some embodiments, significantly lower would be at least one of 60%, 65%, 70%, 75%, 80%, 85%, 90% or 95% of the previously request set point flow rate.

In various embodiments, the variable control valve constricts the fluid flow in the flow path sufficiently to increase the pressure of the fluid from the flow restrictor to be higher than a back pressure from the tool and the proportional control valve is configured to adjust the pressure to the flow restrictor such that the pressure drop across the flow restrictor yields a flow rate that is equal to the second set point. In various embodiments, a reference volume may be configured to verify the actual flow rate by closing the fluid flow using a shut off valve and measuring the pressure rate of decay in the reference volume and adjusting one or both of the variable control valve or the proportional control valve until the second set point flow rate is achieved. In some embodiments, the mass flow controller may use thermal-based flow sensor and a supervision function. The mass flow control may include a thermal-based flow sensor with a fluid conduit with two spaced apart temperature responsive elements affixed to the exterior of the fluid conduit. In some embodiments, a variable control valve can be adjusted to any of at least two different amounts of openings. In some embodiments, a variable control valve can be continuously adjusted to a range of openings. In some embodiments, a the variable control valve can be adjusted to a provide a complete shut-off position. In some embodiments, a shut-off valve upstream from a reference volume, wherein the reference volume is upstream from a flow restrictor, the shut-off valve configured to close the inlet supply to perform a rate of decay operation; and wherein the shut-off valve is a solenoid type valve. In some embodiments, a first pressure sensor is configured to measure fluid pressure (P0) and a first temperature sensor is configured to measure temperature (TO) of a reference volume downstream from the shutoff valve; a proportional control valve, the proportional control valve providing provisions for measuring a second temperature (Ti) and a second pressure (P1) of the fluid contained within the fluid pathway upstream of a flow restriction; the flow restriction providing provision for measuring a third pressure (P2) of the fluid contained within the fluid pathway downstream of the flow restriction; and an outlet from the fluid pathway. In some embodiments, a shut-off valve upstream from a reference volume, the reference volume is upstream from a flow restrictor, the shut-off valve configured to close the inlet supply to perform a rate of decay operation; wherein the shut-off valve is a solenoid type valve, and a proportional control valve that is a solenoid valve to control the pressure to the flow restrictor. In some embodiments, the flow restrictor is chosen from group comprising of an orifice, a nozzle, a porous sintered metal element, a laminar flow structures or tubes.

### BRIEF DESCRIPTION OF DRAWINGS

FIG. 1A is a schematic of a pressure-based flow controller.

FIG. 1B is a schematic of a thermal-based flow controller.

FIG. 2A is a schematic of a mass flow controller with a proportional valve upstream of a flow measurement portion.

FIG. 2B is a schematic of a mass flow controller with a proportional valve downstream of a flow measurement portion.

FIG. 2C is a schematic of a mass flow controller that is capable of pressure monitoring downstream of a flow measurement portion.

FIG. 3 is a schematic of a mass flow controller that includes a pressure sensing element connection downstream of a flow measurement portion and a dynamically adjustable variable valve further downstream of the pressure sensing element.

FIG. 4 is a schematic of a mass flow controller that includes a flow verification capability while using a pressure-based flow sensor.

FIG. 5 is a schematic of a mass flow controller that includes a dynamically variable valve downstream of a flow measurement portion and a pressure sensing element connection further downstream of the variable valve.

FIG. 6 is a schematic of a mass flow controller that includes a flow verification capability while using a pressure-based flow sensor.

FIG. 7 is an illustration showing portions of a complex fluid delivery system within a single large apparatus for processing semiconductor devices.

FIG. 8 is a schematic of a mass flow controller illustrating the components that may be used in an embodiment of the disclosed subject matter.

FIG. 9 is a schematic of a mass flow controller illustrating the components that may be used in an embodiment of the disclosed subject matter.

FIG. 10 is a schematic of a mass flow controller attached to a customer tool.

FIG. 11 is a cross-sectional view of the bottom portion of the mass flow controller.

FIG. 12 is a cross-sectional perspective view of the bottom portion of the mass flow controller.

FIG. 13 is a perspective view of a multitude of mass flow controllers that are connected by a manifold.

FIG. 14 is a flow diagram for a process of matching the metrology of the mass flow controller to the metrology of the customer tool.

FIG. 15 is a flow diagram for a process of tuning the mass flow controller in situ.

FIG. 16 is a block diagram of a computer system that may be implemented in the various embodiments of the control module computer.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phrasing and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items. The use of directional adjectives “inner, “outer,” “upper,” “lower,” “upstream”, “downstream” and like terms, are meant to assist with understanding relative relationships among design elements and should not be construed as meaning an absolute direction in space nor regarded as limiting.

Embodiments are directed to systems and methods for a mass flow controller for responding to a request for a large reduction in flow rate or a large step down in flow rate. For example, a semiconductor manufacturing recipe may require a drop from 500 cc flow rate to drop to 25 cc. The bleed down time or the amount of time a mass flow controls takes to provide the reduction should be fast. Embodiments are directed to providing a variable control valve located downstream from each of the following elements within a mass flow controller: fluid state sensing element (including reference volume, pressure sensor and temperature sensor), proportional valve, additional pressure and temperature sensors, flow restrictor and third pressure sensor. As will be discussed in greater detail below the variable control valve may be used to achieve faster step down response times. In some embodiments, the third pressure sensor may be located downstream from the variable valve and upstream from the fluid outlet. In various embodiments, upon receiving a signal to reduce the flow rate by 80%, 85%, 90% or 95% (greater than 80% or 90%) from the previous flow rate, the variable control value may be constricted thus increasing the pressure at the pressure sensor located closest to the variable control valve. Additionally, when the variable control valve is shutoff the inlet pressure may be increased and the pressure at other pressure sensors may show an increase.

As described herein, by constricting the variable control valve the mass flow controller may be able to change its flow rate significantly while being able to conduct a rate of decay calculation. In some embodiments, the variable control valve may be a solenoid valve to control pressure to the flow restrictor (laminar flow element, orifice, hagen pouiselle tube) that may reduce cost of manufacturing. The variable valve that may be solenoid valve may act as a shutoff valve to perform a rate of decay operation to determine the flow rate. In various embodiments, the variable control valve may be a proportional control valve that is a solenoid to control the pressure to the flow restrictor and located upstream of the flow restrictor. The solenoid type proportional control valve may be used to close the inlet supply to perform a rate of decay operation.

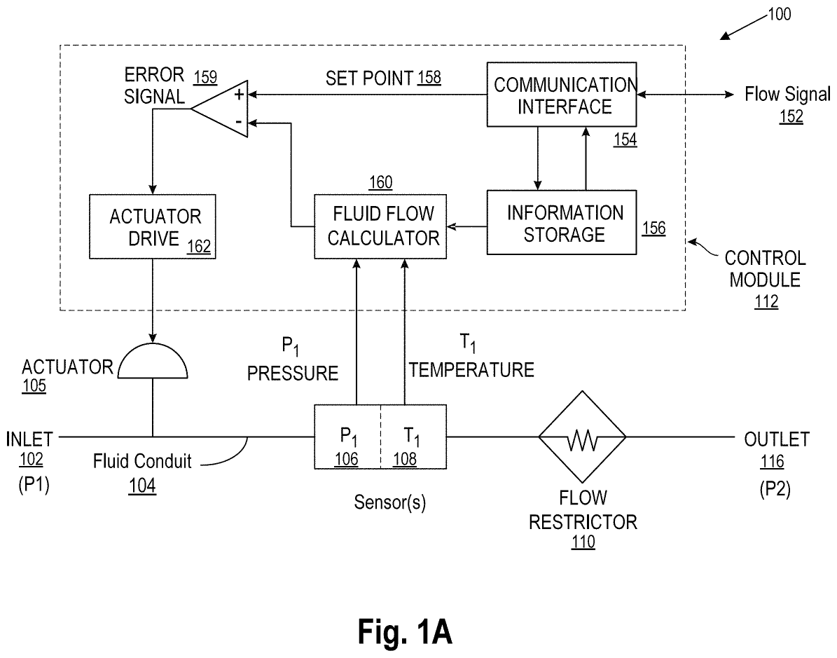

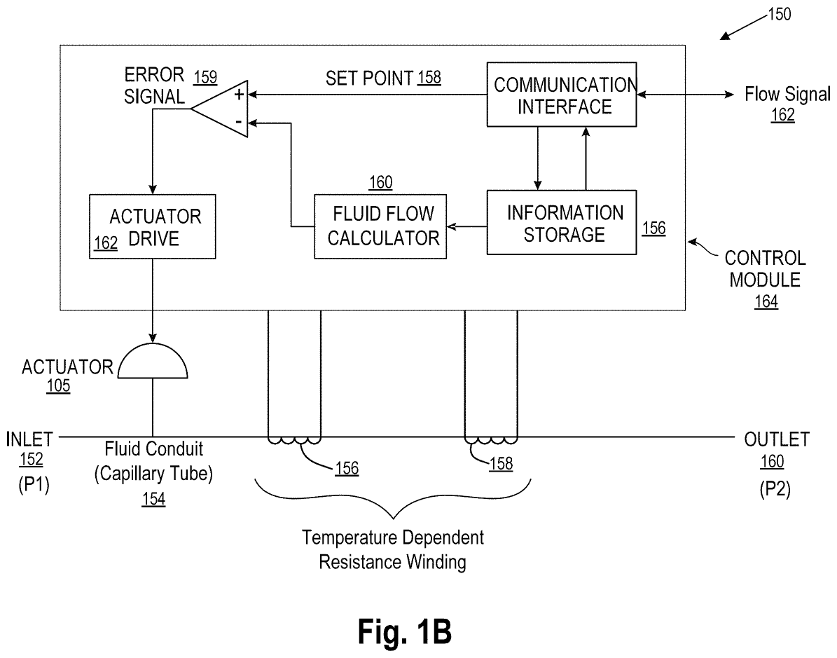

FIG. 1A is a schematic of a pressure-based flow controller. A representative example of a pressure-based flow controller 100 (FIG. 1A) includes fluid inlet 102, a fluid conduit 104 (e.g., a bore in a larger body of material or the like), a pressure sensor 106, a temperature sensor 108, a flower restrictor 110, a control module 112, a flow signal (e.g., set point or flow rate indicator), a fluid outlet 116.

The fluid conduit 104 may be fluidly coupled to the pressure sensor 106 and temperature sensor 108 upstream of a known flow restrictor 110. The pressure sensor 106 and temperature sensor 108 may be individual elements or function as a combined single unit element. The control module 112 may receive signal from and send signals to the temperature and pressure sensors (106 and 108). The control module 112 may control the flow restrictor 110 to achieve desired flow rate by adjusting the pressure and/or temperature to achieve a flow rate. The control module 112 may determine corresponding pressure and temperature conditions for a fluid moving through the conduit 104 whereby the mass flow rate may be calculated based upon characteristics of the known flow restriction provided by the flow restrictor 110. The known flow restrictor 110 may be an orifice, nozzle, porous sintered metal element, or even a laminar flow structure such as a plurality of long narrow flow passageways. Knowledge of the pressure-temperature-flow characteristics of the flow restriction is often obtained by measurements made during a flow calibration process but other methods, such as direct measurement of mechanical dimensions, may also be feasible in some designs.

The control module 112 may include circuitry to control the various elements shown in FIG. 1A. The control module 112 may generate a flow rate signal 114 and provide excitation, sense, measure and calculate based on the received signals. In some embodiments, the control module 112 may receive a pressure measurement from the pressure sensor 106 and receive a temperature from the temperature sensor 108. The control module 112 may adjust the flow restrictor 110 based on the desired set point received from an external system. The control module 112 may be configured to use the measured pressure to determine the actual flow rate based on historical calibration information for the system 100. The pressure sensor 106 may generate a pressure P1 and generate a signal that represents a pressure to the control module 112 that controls the flow restrictor 110. The temperature sensor 108 may generate a temperature Ti and generate a signal to the control module 112 that represents a temperature Ti to the control module 150. Next the gas/fluid may pass through a flow restrictor 110 to the outlet 116.

FIG. 1B is a schematic of a thermal-based flow controller 150. A representative example of a thermal-based flow sensor (FIG. 1B) includes a fluid inlet valve 152, a fluid conduit 154 (typically a capillary tube) with two spaced apart temperature responsive elements 156 and 158 (herein illustrated as resistance windings) affixed to the exterior of the fluid conduit. Electronic circuitry in the control module 154 provides excitation to the temperature responsive elements and senses chosen properties of the elements whereby heat transfer caused by a fluid moving through the conduit 154 may be measured and a corresponding mass flow calculated. A typical mass flow meter may additionally include a known laminar flow element (not shown) fluidly coupled in parallel with the thermal-based flow sensor whereby a proportionate fluid flow passes through the laminar flow element. The control module 164 may generate a flow signal 162 that is indicative of the flow rate of the fluid through the fluid conduit 154.

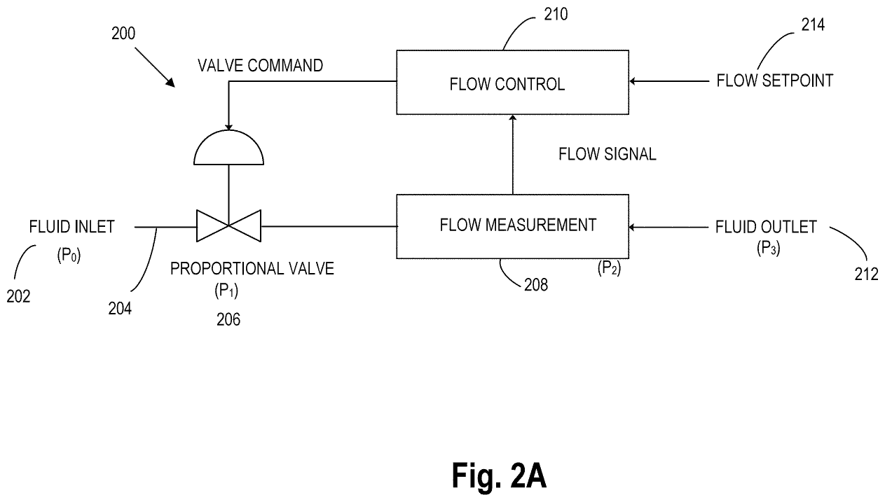

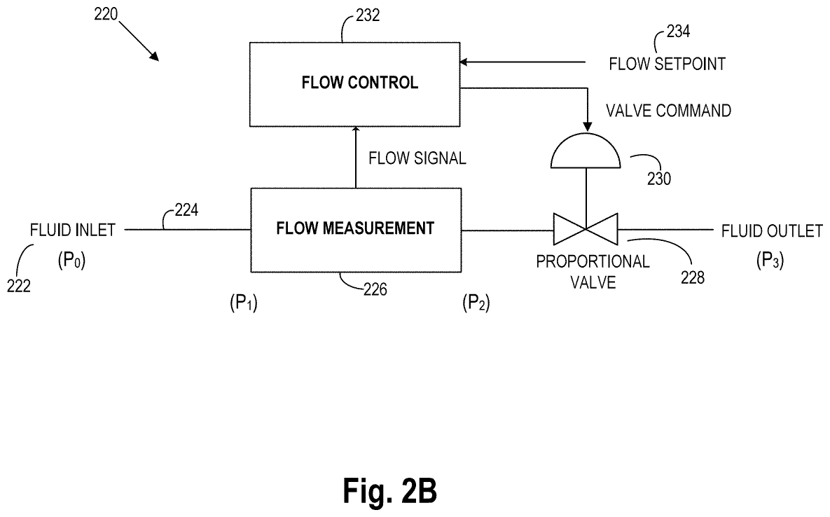

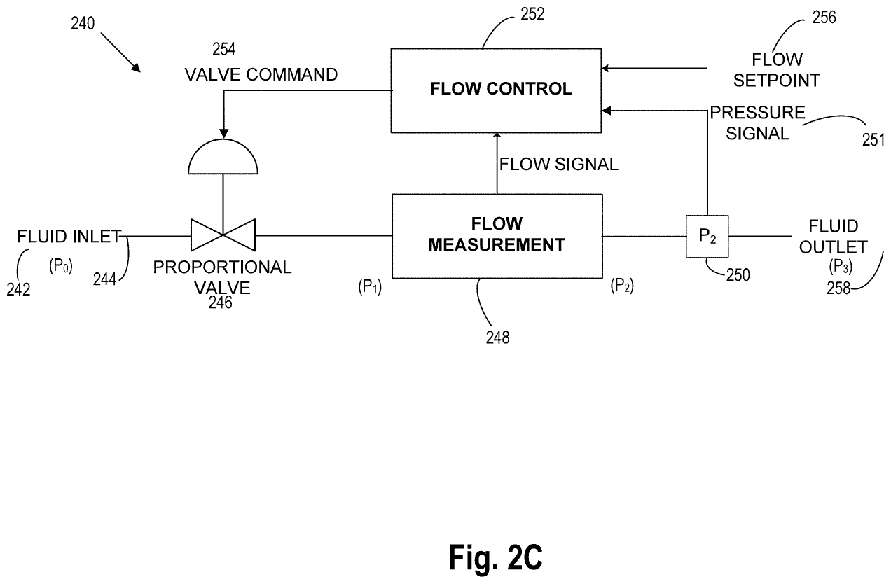

FIG. 2A is a schematic of a mass flow controller 200 that includes a fluid inlet 202 at pressure P0, a fluid conduit 204, a proportional valve 206, a flow measurement module 208, a flow control 210, a fluid outlet 212, and a flow set point 214. The proportional valve 206 may be located upstream of a flow measurement module 208. A representative mass flow controller 200 (MFC) may include a flow measurement module 208 and a proportional valve 206 upstream (FIG. 2A) of the flow measurement module 208, the upstream valve being actively modulated by a flow control module 210 (typically electronic circuitry) to adjust the fluid flow to match a desired flow set point.

Referring to FIG. 2B, FIG. 2B illustrates a mass flow controller 220 that includes a fluid inlet 222, a fluid conduit 224, a flow measurement module 226, a proportional valve 228, a valve command 230, a flow controller 232 and a flow set point 234. The flow measurement module 226 may include a pressure sensor, a temperature sensor. The mass flow controller 220 may include a proportional valve 228 downstream (FIG. 2B) of the flow measurement module 210, the downstream valve 228 being actively modulated by a flow control module 232 (typically electronic circuitry) to adjust the fluid flow to match a desired flow set point 234. The mass flow controller 220 arrangement with an upstream proportional valve 228 (FIG. 2A) advantageously provides the flow measurement portion some isolation from deleterious effects of pressure transients at the fluid inlet 222. In case of a thermal-based flow sensor (FIG. 1B), the upstream proportional valve MFC arrangement (FIG. 2A) may directly subject the flow sensor to very low fluid outlet pressures which may adversely change to nonlinear heat transfer caused by fluid moving through the conduit. The MFC arrangement with a downstream proportional valve 228 (FIG. 2B) advantageously provides the flow measurement portion 226 some isolation from deleterious effects of low pressure and/or pressure transients at the fluid outlet 228. However, such arrangement directly exposes the flow measurement portion 226 to the deleterious effects of pressure transients at the fluid inlet 222. In case of a pressure-based flow sensor (e.g. FIG. 1A), the downstream proportional valve arrangement (FIG. 2B) possibly makes the pressure drop across the flow restriction sub-critical. The pressure at the downstream side of the flow measurement portion 248 may be monitored (FIG. 2C) to determine whether a thermal-based flow measurement portion is operating in nonlinear conditions or whether a pressure-based flow measurement portion is operating in sub-critical conditions.

FIG. 2C is a schematic of a mass flow controller 240 that is capable of pressure monitoring downstream of a flow measurement portion. The mass flow controller 240 includes a fluid inlet 242, a fluid conduit 244, a proportional valve 246, a flow measurement 248, a pressure sensor 250, a flow control module 252, a valve command 254, a flow set point 256 and a fluid outlet 258. The pressure at the downstream side of the flow measurement portion 248 may be monitored (FIG. 2C) to determine whether a thermal-based flow measurement portion is operating in nonlinear conditions or whether a pressure-based flow measurement portion 248 is operating in sub-critical conditions. The flow control module 252 may be configured to receive a flow set point 256 and send commands to the proportional valve 246. Pressure sensor 250 generates a pressure signal 251 as an input to flow control 252. The flow control 252 receives the pressure signal 251 and determines the flow rate and may adjust the proportional valve 246.

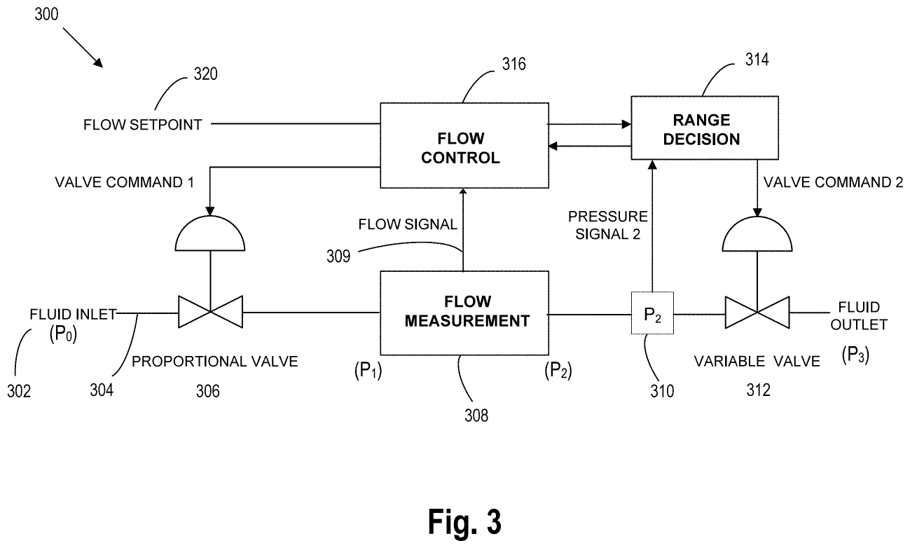

FIG. 3 is a schematic of a mass flow controller 300 that includes a fluid inlet 302, fluid conduit 304, a proportional valve 306, a flow measurement module 308, a pressure sensor 310, a variable valve 313, a range decision module 314, a flow control 316, a flow set point 320 and a fluid outlet 322. Mass flow controller 300 includes a pressure sensor 310 downstream of a flow measurement module 314 and a dynamically adjustable variable valve 312 further downstream of the pressure sensor 310. An embodiment of the mass flow control controller 300 (FIG. 3) includes a proportional valve 306 upstream of a flow measurement module 308, a pressure sensor 310 fluidly connected to determine a fluid pressure downstream of the flow measurement module 308, and a dynamically adjustable variable valve 312 downstream of both the flow measurement module 308 and the pressure sensor 310. The downstream pressure sensor 310 and variable valve 312 may be used with either a pressure-based or a thermal-based flow sensor. The variable valve 312 may be controllably adjusted (set) to any of at least two different amounts of opening (fluid conductance).

The variable valve 312 may additionally provide a complete shut-off in a third adjustment condition (setting) although this capability is optional. The variable valve 312 may be of a type with a continuously adjustable range of openings. The pressure sensor 310 may be of any convenient type and may optionally further include fluid temperature measuring provisions such as a temperature sensor.

An adjustment decision may be made, and opening of the variable valve 312 consequently adjusted, in response to a magnitude of the determined fluid pressure downstream of the flow measurement module 308 relative to a chosen threshold. The chosen threshold may be selected to ensure the flow measurement module 308 is subjected to at least a minimum (one half atmosphere, for example) determined downstream fluid pressure. Alternatively, in some embodiments, the chosen threshold may be selected to ensure the flow measurement portion is operating in a desired linear regime. The opening of the variable valve 310 may be held relatively constant, and specifically changed according to known limitations of the flow measurement module 308, with intentional hysteresis caused by selecting a new chosen threshold contemporaneous with each specific change of opening. Yet another control scheme may dynamically modulate the adjustment of the variable valve 312 to maintain a relatively constant determined fluid pressure downstream of the flow measurement module 308. In yet another embodiment, the flow controller 316 may use a control scheme to select the chosen threshold based at least in part upon the pressure drop across the flow measurement module 308. In another embodiment, the flow controller 316 may use a control method to select the chosen threshold based at least in part on the change of pressure across the flow measurement module 308. The proportional valve 306 and the variable valve 312 control the flow of the fluid through the mass flow controller 300. The variable valve 312 may be used to help the mass flow controller 300 have a faster step-down response when reducing the flow by more than 50%. In other embodiments, the variable valve 312 may be used to help the mass flow controller 300 have a faster step up response when increasing the flow of the fluid by more than 50%.

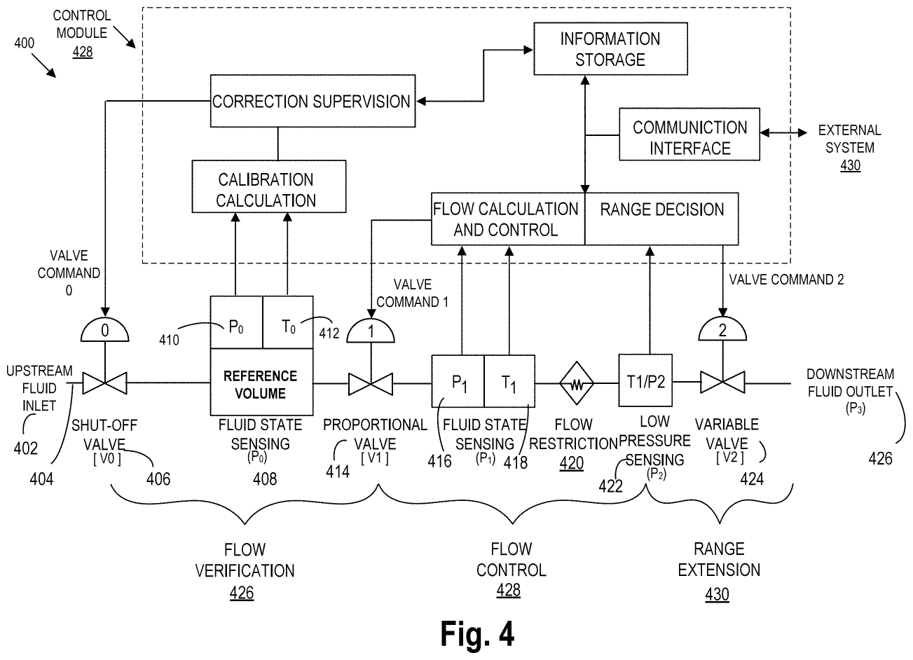

FIG. 4 is a schematic of a mass flow controller 400 that includes a flow verification capability while using a pressure-based flow sensor. The mass flow controller 400 may comprise (in upstream to downstream flow sequence) a fluid inlet 402, to a fluid pathway 404, a controllable shutoff valve 406, provisions for measuring a reference temperature 412 (TO) and a reference pressure 410 (P0) of a fluid contained within a reference volume 408 of the fluid conduit 404, a proportional control valve 414, provisions for measuring a first temperature 418 (Ti) and a first pressure 416 (P1) of the fluid contained within the fluid pathway upstream of a flow restriction 420, provisions for measuring a second pressure 422 (P2) of the fluid contained within the fluid pathway downstream of the flow restriction 420, a variable valve 424, and an outlet 426 from the fluid pathway 404. Knowing the aggregate volume of fluid contained within the reference volume 408, plus any directly connected fluid conduit 404 between the shutoff valve 406 and the proportional valve 414, enables flow verification (self-calibration) of the embodiment mass flow controller 400. Flow verification method includes closing the shutoff valve 406 to isolate the fluid conduit 404 from the inlet 402 while controlled mass flow continues through the outlet, making repeated measurements of the reference temperature 410 (TO) and the reference pressure 412 (P0) of the fluid contained within the reference volume 408 of the fluid conduit 404 for a period of time, opening the shutoff valve 406 to re-establish fluid pathway connection to the fluid inlet 402, calculating a verified flow signal using pressure-volume-temperature (PVT, also known as Rate Of Fall, RoF) methods related to the aggregate volume of fluid, and providing the verified flow signal to a supervision function (control module 428). The control module 428 may subsequently choose whether to enable additional self-calibration processes, change a system parameter, merely store the results, or take other actions. For example, the control module 428 may direct that a series of flow verification measurements be performed corresponding to different values of determined fluid pressures (P1, P2) and fluid temperature (Ti) adjacent the flow restriction 420. This series of flow verification measurements readily determines a calibration curve, for a discrete flow restriction, based at least in part upon the verified flow signals. It should be noted the control module 428 does not require any particular critical ratio (P1/P2) be maintained between the determined upstream (P1) and downstream (P2) pressures when a known calibration curve is obtained. The known calibration curve may be entirely empirical or conform to a theoretical model.

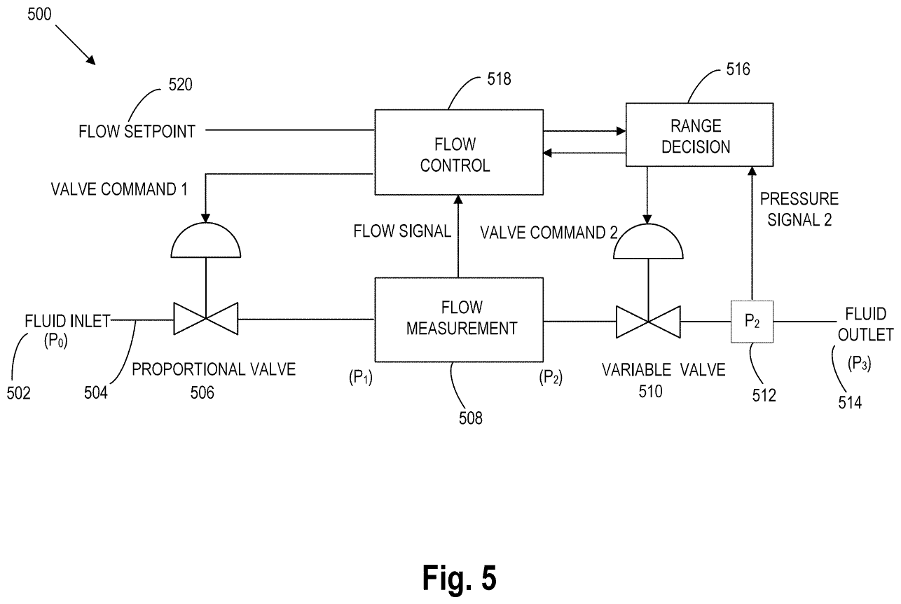

FIG. 5 is a schematic of a mass flow controller 500 that includes a dynamically variable valve downstream of a flow measurement module 508 and a pressure sensing element 512 further downstream of the variable valve 510. Another embodiment of a mass flow controller 500 (FIG. 5) includes a proportional valve 506 upstream of a flow measurement portion 508, a dynamically adjustable variable valve 510 downstream of the flow measurement portion, and a pressure sensing element fluidly connected to determine a fluid pressure downstream of the flow measurement portion and the adjustable variable valve. The downstream pressure sensing element 512 and variable valve 510 combination may be used with either a pressure-based or a thermal-based flow sensor. The variable valve 510 may be controllably adjusted (set) to any of at least two different amounts of opening (fluid conductance). The variable valve 510 may additionally provide complete shut-off in a third adjustment condition (setting) although this capability is optional. The variable valve 510 may be of a type with a continuously adjustable range of openings. The pressure sensing element 512 may be of any convenient type and may optionally further include fluid temperature measuring provisions. An adjustment decision may be made by the range decision 516, and opening of the variable valve 510 consequently adjusted, in response to operating conditions of the apparatus as further explained below.

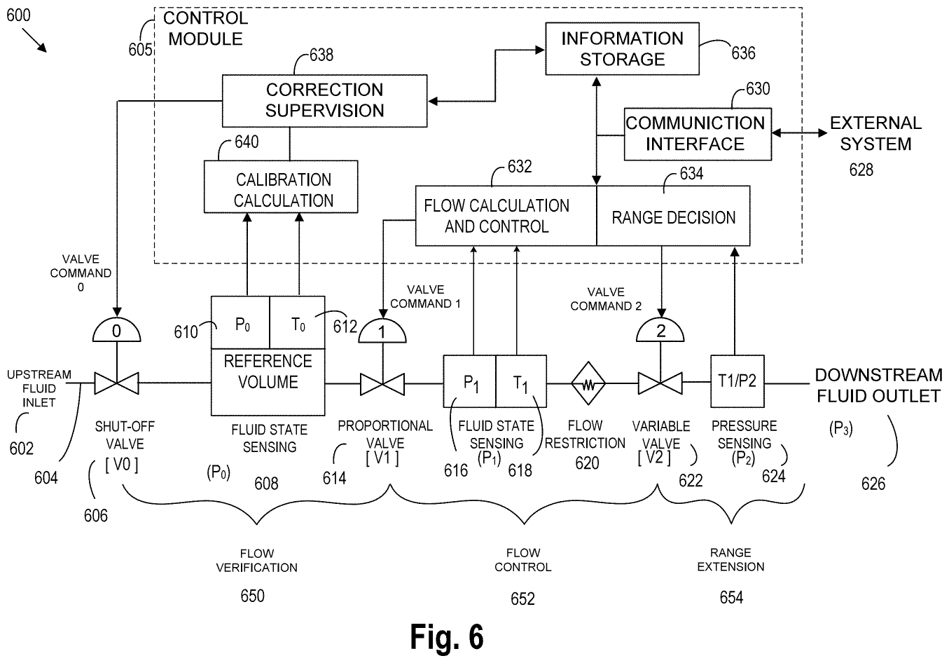

FIG. 6 is a schematic of a mass flow controller 600 that includes a flow verification capability while using a pressure-based flow sensor. In various embodiments, of a mass flow controller 600 may additionally include a flow verification capability (FIG. 6). The mass flow controller 600 includes (in upstream to downstream flow sequence) an inlet 602, a fluid pathway 604, a controllable shutoff valve 606, provisions for measuring a reference temperature 612 (TO) and a reference pressure 610 (P0) of a fluid contained within a reference volume portion 608 of the fluid pathway 604, a proportional control valve 814, provisions for measuring a first temperature 618 (Ti) and a first pressure 616 (P1) of the fluid contained within the fluid pathway upstream of a flow restriction 620, the flow restriction 620, a variable valve 622, provisions for measuring a second pressure (second pressure sensor 624) (P2). In various embodiments the second pressure sensor 624 may measure the fluid contained within the fluid pathway 604 downstream of the flow restriction 620 and the variable valve 622, and an outlet from the fluid pathway 604. Knowing the aggregate volume of fluid contained within the reference volume 608, plus any directly connected fluid pathway portions between the shutoff valve 606 and the proportional valve 614, enables flow verification (self-calibration) of another embodiment of the mass flow control apparatus. Flow verification involves closing the shutoff valve 606 to isolate the fluid pathway 604 from the inlet 602 while controlled mass flow continues through the outlet 626, making repeated measurements of the reference temperature 612 (TO) and the reference pressure 610 (P0) of the fluid contained within the reference volume 608 of the fluid pathway 604 for a period of time, opening the shutoff valve 606 to re-establish fluid pathway connection to the inlet 602, calculating a verified flow signal using pressure-volume-temperature (PVT, also known as Rate Of Fall, RoF) methods related to the aggregate volume of fluid, and providing the verified flow signal to a control module 605. The control module 605 may subsequently choose whether to enable additional self-calibration processes, change a system parameter, merely store the results, or take other actions. For example, the control module 605 may direct that a specific valve command be presented to the variable valve 622 and a series of flow verification measurements performed corresponding to different values of determined fluid pressures (P1, P2) and fluid temperature (Ti) adjacent the flow restriction 620 and variable valve 622. This series of flow verification measurements readily determines a calibration curve, for a composite flow restriction comprising the original discrete flow restriction plus the partially open variable valve 622, based at least in part upon the verified flow signals.

In various embodiments, the control module 605 may relate to making an adjustment decision using a range decision 634, and adjusting an opening of the variable valve 622 downstream of the flow measurement portion (reference volume 608), in response to a magnitude of one or more determined fluid pressures relative to a chosen threshold. In particular, if the flowing fluid pressure drop across the flow restriction 620 and variable valve 622 (P1-P2) is less than a chosen threshold, then a revised valve command may be presented to the variable valve 622 causing the variable valve 622 to assume a less open more flow restricting condition. A flow verification measurement may then provide a verified flow signal for comparison with calculated mass flow (using P1, Ti, P2) through the composite flow restriction (which is comprised of the discrete flow restriction 620 and the variable valve 622) obtained by using a previously obtained calibration curve associated with the particular composite flow restriction 620. If the verified flow signal and calculated mass flow are suitably close to identical (for example, 0.5%), then the variable valve may be considered as having returned to a known condition and the supervision function may affirm use of the previously obtained calibration curve with the particular composite flow restriction. It should be noted the control module does not require any particular critical ratio (P1/P2) be maintained between the determined upstream first (P1) and downstream second (P2) pressures when a known calibration curve has been obtained. The known calibration curve may be entirely empirical or conform to a theoretical model.

In low flow and low set point applications additional advantages may be obtained from a variable valve 622 that is additionally able to provide complete shut-off in a third adjustment condition (setting). In any of the previously described embodiments a lower auto-shutoff threshold (for example, 0.25% of full-scale) may be provided to the flow control portion of a mass flow controller such that a set point request less than the auto-shutoff threshold causes the flow control portion to immediately command the proportional valve to its most flow restricting condition without need to obtain a calculated mass flow. Similarly, a variable valve capable of shutoff may be simultaneously commanded to close completely and thereby bring fluid flow to a very rapid halt. In the situation of embodiments (FIG. 3 & FIG. 4) wherein the downstream second pressure (P2) is determined immediately adjacent to the discrete flow restriction, and upstream of the variable valve (described above), then a variable valve having a continuously adjustable range of openings may be advantageously used to control the pressure drop (P1-P2) across the flow restriction while the proportional valve is commanded into its most flow restricting or other convenient condition.

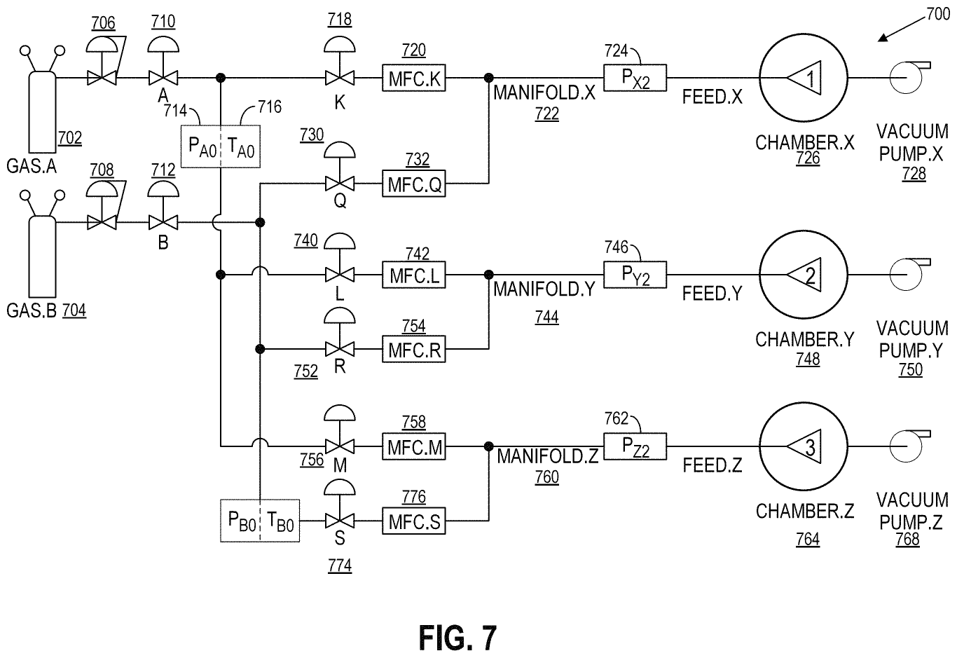

FIG. 7 is an illustration showing portions of a complex fluid delivery system within a single large apparatus for processing semiconductor devices. Illustrated in FIG. 7 is an abbreviated schematic illustrating portions of a complex fluid delivery system within a single large apparatus for processing semiconductor devices. A plurality of new embodiment mass flow controllers (of the type illustrated in FIG. 5 & FIG. 6) may be used with a plurality of process gas species to feed reactants into a plurality of vacuum chambers. Such an apparatus is often referred to as a “tool.” As shown in the abbreviated schematic, a group (“pallet”) of mass flow controllers (MFC.K, MFC.L) enable the simultaneous combination of several different process gases (GAS.A, GAS.B) into a single manifold (MANIFOLD.X) which feeds a gas distribution structure (“showerhead”-1) inside a vacuum chamber (CHAMBER.X). Insufficient conductance in some manifold plumbing (FEED.X) may result in the downstream pressure (Px2), of a particular group of mass flow controllers, becoming too high to maintain choked flow conditions within one or more mass flow controllers within the group. In an alternative scenario, the downstream pressure (Px2) within the manifold (MANIFOLD.X) may be so low the requisite operating conditions internal to a specific new embodiment mass flow controller (e.g. MFC.K) cannot be maintained as desired and the corresponding variable valve within the MFC adjusted as previously discussed. The pressure within the manifold may be monitored (Px2) and a corresponding signal provided to all mass flow controllers within the group (MFC.K, MFC.Q) as an alternative to each mass flow controller having a separate third pressure sensor. Individual mass flow controller adjustment decisions may then proceed based upon the shared third pressure sensor signal. Each individual new embodiment mass flow controller may contain a dedicated supervision function which determines a course of action or a supervision function may be associated with and shared among all new embodiment mass flow controllers comprising a specific pallet group of MFCs.

A mass flow control apparatus comprising: a proportional valve upstream of a flow measurement portion, a pressure sensing element fluidly connected to determine a fluid pressure downstream of the flow measurement portion and a dynamically adjustable variable valve downstream of both the flow measurement portion and the pressure sensing element connection. Further the mass flow control apparatus comprising of a pressure-based flow sensor including a fluid conduit with fluidly coupled pressure and temperature sensing provisions upstream of a known flow restriction. Alternatively, the mass flow control apparatus includes a thermal-based flow sensor, which has fluid conduit with two spaced apart temperature responsive elements affixed to the exterior of the fluid conduit. Further the dynamically adjustable variable valve can be adjusted to any of at least two different amounts of openings, or continuously adjusted to a range of openings or adjusted to a provide a complete shut-off position.

A mass flow control apparatus includes, an inlet to a fluid pathway; a controllable shutoff valve, the controllable shutoff valve providing provisions for measuring a reference temperature (TO) and a reference pressure (P0) of a fluid contained within a reference volume of the fluid pathway; a proportional control valve, the proportional control valve providing provisions for measuring a first temperature (Ti) and a first pressure (P1) of the fluid contained within the fluid pathway upstream of a flow restriction; the flow restriction providing provision for measuring a second pressure (P2) of the fluid contained within the fluid pathway downstream of the flow restriction; a variable valve; and an outlet from the fluid pathway. The flow restriction is chosen from group comprising of an orifice, a nozzle, a porous sintered metal element or a laminar flow structures. Further the mass flow control apparatus includes a supervision function. The supervision function may choose an action from group comprising of self-calibration process, change of system parameter or storage of results.

A mass flow control apparatus including a mass flow controller further which includes a proportional valve upstream of a flow measurement portion; a dynamically adjustable variable valve downstream of the flow measurement portion; a pressure sensing element fluidly connected to determine a fluid pressure downstream of the flow measurement portion and downstream of the variable valve. The mass flow control apparatus including the plurality of mass flow controllers; a plurality of gas species to feed reactants into a plurality of vacuum chambers.

A mass flow control apparatus including an inlet to a fluid pathway; a controllable shutoff valve, the controllable shutoff valve providing provisions for measuring a reference temperature (TO) and a reference pressure (P0) of a fluid contained within a reference volume of the fluid pathway; a proportional control valve, the proportional control valve providing provisions for measuring a first temperature (Ti) and a first pressure (P1) of the fluid contained within the fluid pathway upstream of a flow restriction; the flow restriction, a variable valve providing provision for measuring a second pressure (P2) of the fluid contained within the fluid pathway downstream of the flow restriction and downstream of the variable valve; and an outlet from the fluid pathway.

A method for a mass flow control apparatus including determining a fluid pressure downstream of a flow sensor; responding to the fluid pressure downstream; and adjusting dynamically a variable valve downstream of the flow sensor to maintain desired operating conditions in the flow sensor; and maintaining and extending the useful operating range of the mass flow control apparatus. The method further includes a flow verification capability. The method further wherein the flow verification capability comprises the steps of: closing a shutoff valve to isolate a fluid pathway from an inlet while controlled mass flow continues through an outlet; making repeated measurements of a reference volume of a fluid pathway for a period of time; opening the shutoff valve to re-establish fluid pathway connection to the inlet; calculating a verified flow signal using pressure-volume-temperature methods; and providing a verified flow signal to a supervision function. Wherein the supervision function directs that a series of flow verification measurements be performed corresponding to different values of determined fluid pressures and fluid temperatures adjacent the flow restriction. Wherein the supervision function determines a calibration curve for a discrete flow restriction based on the flow signals generated by the flow verification measurements.

Referring to FIG. 7, FIG. 7 shows an apparatus 700 having a plurality of self-correcting mass flow controllers may be used with a plurality of gas species fed to a plurality of vacuum chambers 726, 748, and 764 for processing semiconductor devices within a single large apparatus often referred to as a “tool.” A group (“pallet”) of mass flow controllers (720, 732, 742, 754, 758, and 776) allow the simultaneous combination of several different gases into a single manifold (742, 744, and 760) which feeds a gas distribution structure (“showerhead”) inside a vacuum chamber (726, 748 and 764). Insufficient conductance in the manifold plumbing may result in the downstream pressure, of a particular group of mass flow controllers, becoming too high to maintain choked flow conditions within one or more mass flow controllers within the group. The pressure within the manifold may be monitored using pressure sensor 724, pressure sensor 746 and pressure sensor 762 and a corresponding signal provided to all mass flow controllers within the group as an alternative to each mass flow controller having a separate third pressure sensor. Individual mass flow controller self-correction may then proceed based upon the shared third pressure sensor signal or according to commands emanating from the tool master control (a control system external to the control module of each mass flow controller).

FIG. 7 illustrates an apparatus 700 that includes various system including, a gas provider 702 and a gas provider 704. The apparatus 700 has a plurality of valves, 706, 708, 710, 712, 718, 730, 740, 752, 756, and 774. The apparatus 700 includes one or more pressure sensors to determine the flow rate of the gases. The pressure sensors 714, 716, 724, 746, 762, 770, and 772 may be used to determine the pressure outside of the MFCs 720, 732, 742, 754, 758, and 776.

Having thus described several aspects of at least one embodiment of this invention, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only.

The disclosed subject matter describes a system and method for calibrating a mass flow controller that modulates the flow rate for a gas. The mass flow controller receives a calibrated volume input such that the internal calibration system of the mass flow controller aligns with the external metrology or external measurement system that is used as a reference for flow measurement. The mass flow controller may perform a rate of decay measurement on the calibrated volume of the gas to perform a volume measurement. The rate of decay measurement for the calibrated volume may be used to make an adjustment to the volume measurement to match the calibrated volume input. The mass flow controller may make the same adjustment on subsequent volume measurements for the same type of gas.

The mass flow controller may receive an input for actual flow performance at various different configuration points on the flow spectrum of the mass flow controller. The flow spectrum may flow from as low as 0.25% to full scale at 100%. The mass flow controller may perform a rate of decay measurement to measure actual flow rate going out of the mass flow controller at the various different configuration points. The actual flow performance input may be used to make an adjustment to the rate of decay measurement to match the metrology or measurement system for each configuration point. The actual flow performance input could also be used to re-calculate the device's internal calibration curve or table or the method of calculating the control parameter used to control flow delivery for a received setpoint to the mass flow controller. The mass flow controller may make the same adjustment on subsequent measurements for the same type of gas at each configuration point.

The mass flow controller may auto tune in situ by receiving input from the user on thresholds for response overshoot and overshoot flow requirements and adjusting its internal valve characterization, for example, changing its P, I, D values in a PID control mechanism while on the tool to meet the required input specification.

The in situ rate of decay measurement may be used to detect deviations of accuracy from a desired flow rate. The mass flow controller may alert a user to the deviations by setting off an alarm. The user may configure alarm thresholds over any communication protocol such as DeviceNet, EtherCat, EtherNet, RS485, RS232, Profibus or various other digital communication methods. either through a wired communication platform or wireless methods.

The user may communicate with the mass flow controller over a wireless communication protocol such as Bluetooth. The wireless communication allows for ease of configuration in the field and enables monitoring of signals from the flow controller such as flow, pressure, temperature, rate of decay flow rate, auto correction flow amount, gas, full scale and other such critical parameters key to the successful operation of the device.

The mass flow controller makes use of an elastomer, corrosion resistant material such as PCTFE, PTFE, TEFLON, and NYLON between the valve seat and the valve body components. The elastomer allows for better valve shut off performance. The mass flow controller may have various shut off valve types including, but not limited to solenoid, piezo electric, and stepper motor. The elastomer seat and other elastomer components may improve the “valve leak-by” performance of the mass flow controller. The “valve leak-by” is the measure of gas that leaks through the valve when the valve is shut.

The mass flow controller may measure “valve leak-by” by using the rate of decay measurement. A command may be sent to the mass flow controller to measure the “valve leak-by” by performing a rate of decay measurement.

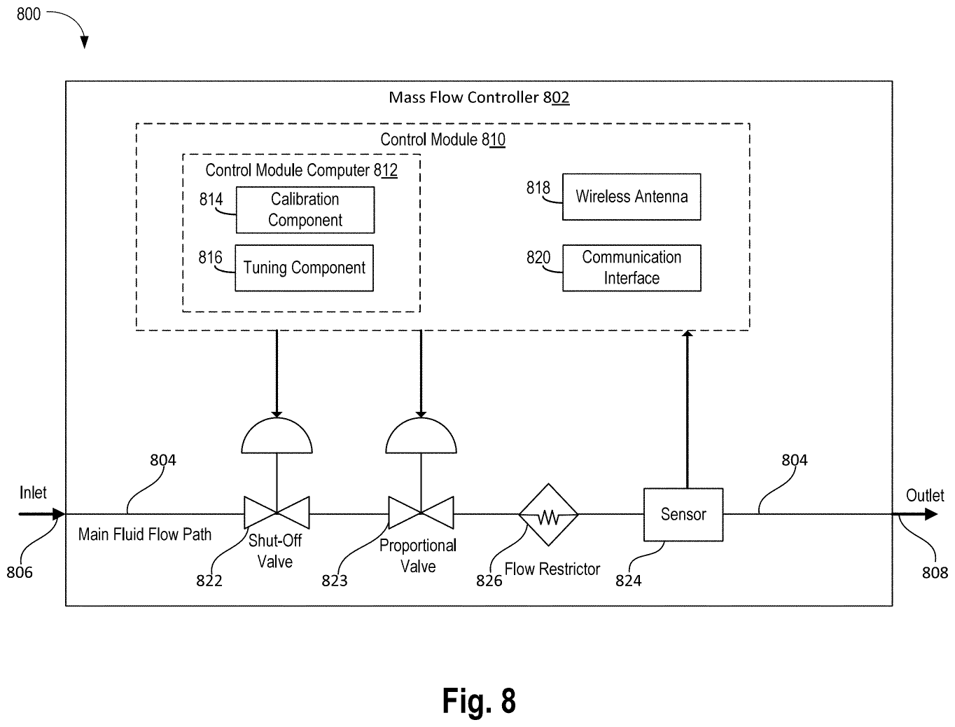

Referring to FIG. 8, FIG. 8 is a schematic 800 of a mass flow controller 802 illustrating the components that may be used in an embodiment of the disclosed subject matter. The mass flow controller 802 adjusts the flow rate of a fluid that is flowing through a main fluid flow path 804 in the mass flow controller 802. The fluid flowing through the mass flow controller 802 may be a gas or liquid. Fluid may be directed into the main fluid flow path 804 of the mass flow controller 802 through an inlet 806. The mass flow controller 802 may have one or more inlets 806. The fluid in the main fluid flow path 804 may be directed out of the mass flow controller through one or more outlets 808. The mass flow controller 802 includes a control module 810, a shut off valve 822, a proportional valve 823, one or more sensors 824, and a flow restrictor 826.

The control module 810 processes information that is received and transmitted by the mass flow controller 802. The control module 810 may send signals to the shut off valve 822 and proportional valve 823 to control the flow rate of fluid through the mass flow controller 802. The control module 810 receives data from the one or more sensors 824 to determine the flow rate of fluid through the main fluid flow path 804. The control module 810 may receive a setpoint flow rate and store it in memory. The control module 810 may determine the difference between the setpoint flow rate and the flow rate that was determined from the data from the one or more sensors 824. Based on the difference in flow rates, the control module 810 may send signals to the proportional valve 823 to minimize the difference between the setpoint flow rate and the flow rate determined from the data from the one or more sensors 824.

The control module 810 includes a control module computer 812, a wireless antenna 818, and a communication interface 820. The control module computer 812 stores data, performs calculations, determines the flow rate of the fluid in the main fluid flow path 804 based on the data from the one or more sensors 824, determines a setting for the proportional valve 823, and determines the state of the shut off valve 822.

The control module computer 812 determines the settings of the components of the mass flow controller 802 such as the shut off valve 822 and the proportional valve 823. In addition to determining the component settings of the mass flow controller 802, the control module computer 812 may produce output for the state of the mass flow controller. Output may include, but is not limited to: the current flow rate, the current calibration state, the current tuning state, and an alarm state. The control module computer 812 may set off an alarm in response to data that the control module computer collects from the mass flow controller 802. Data that the control module collects may include data from the one or more sensors 824. The control module computer may also receive signals from the wireless antenna 818 and the communication interface 820.

The control module computer 812 may calculate the flow rate of a fluid moving through the mass flow controller 802 based on the data from the one or more sensors 824. The flow rate calculation for a gas may be performed based on the ideal gas law. The ideal gas law allows for the calculation of the number of moles of a gas if the pressure, temperature, and volume of the gas are known. The pressure, temperature, and volume of a gas flowing through the main fluid flow path 804 may be determined in various ways based on data from the one or more sensors 824. Different compositions of gases will give slightly different data from the one or more sensors 824. Therefore, a calibration must be performed for each composition of gas that flows through the mass flow controller 802. In one embodiment, a rate of decay measurement may be performed to calibrate the mass flow controller by measuring the change in flow rate when the shut-off valve 822 is closed. In the rate of decay measurement, the shut-off valve 822 is closed upstream of the one or more sensors 824. The one or more sensors 824 measure the change in the flow rate. Because the shut-off valve 822 is closed, it may be assumed, in the rate of decay measurement, that the flow rate goes to zero. A volume may be determined from the rate of decay measurement.

The control module computer 812 includes a calibration component 814 and a tuning component 816. The calibration component 812 performs calibrations for compositions of gas. The calibrations are necessary for the control module computer 812 to determine a precise flow rate for a given composition of gas. In one embodiment, the mass flow controller 802 may receive a calibrated volume input signal, which is transmitted to the calibration component, from a customer tool. The mass flow controller 802 may receive a volume of a composition of gas that coincides with the calibrated volume input signal. To calibrate, a rate of decay measurement is performed after the volume of the composition of gas is received by the mass flow controller 802. The control module computer 812 determines a calculated volume of the composition of gas, based on the rate of decay measurement. The calibration component 812 may create a calibration parameter to adjust the calibration of the mass flow controller 802, such that the calculated volume of the composition of gas is equal to the calibrated volume input signal. The calibration parameter may adjust the calibration of the mass flow controller 802 differently based on the flow rate and the composition of the gas. For that reason, the calibration parameter may be created based on multiple calibrated volume input signals. For each calibrated volume input signal, a rate of decay measurement is performed and the calibration parameter is updated. The mass flow controller 802 will share a common metrology with customer equipment after calibration. The calibration component 814 also allows for the mass flow controller 802 to be calibrated in the field.

The tuning component 816 determines settings for the proportional valve 823. The mass flow controller 802 matches the rate of fluid flow through the mass flow controller 802 to a setpoint flow rate. The tuning component 816 receives response overshoot and overshoot flow requirements and sets tuning parameters. Based on the tuning parameters, the tuning component 816 sends signals to adjust the internal valve characterization. The response overshoot and overshoot flow requirements dictate how the proportional valve 823 is adjusted based on the calculated flow rate and the setpoint flow rate. Overshoot occurs when the calculated flow rate oscillates around a setpoint flow rate. Ideally, the tuning parameters minimize overshoot. The tuning parameters may vary based on the composition of fluid and the flow rate of the fluid. Therefore, the tuning component 816 may receive different response overshoot and overshoot flow requirements based on the flow rate and based on the composition of gas.

In one example of tuning parameters adjusting the internal valve characterization, the tuning component 816 may change the P,I,D values in a PID control mechanism. In a PID control mechanism, P stands for proportion and increases an adjustment based on the flow rate difference, which is the difference between the calculated flow rate and the setpoint flow rate. I stands for integral and represents the accumulated flow rate difference over time. D stands for derivative and represents the change in the flow rate difference over time. The adjustment to the proportional valve 823 is proportional to the sum of the P, I, and D values. The tuning parameters may set a weight to the P, I, and D values. For example, increasing the weight of the D value may have the effect of dampening the response of the proportional valve 823 adjustment. Additionally, the time to determine the I and D values may also be set by the tuning parameters. Like the calibration parameters, the ideal tuning parameters may change based on the flow rate and the gas composition. For that reason, the tuning parameters may be set at multiple flow rates for each gas composition. And like the calibration component 814, a customer tool may be used to set the tuning parameters of the tuning component 816.

The wireless antenna 818 receives and transmits data by wireless communication. The calibrated volume input signal may be received by the wireless antenna 818. Likewise, the response overshoot and overshoot flow requirements may be received by the wireless antenna 818. The properties of fluids moving through the mass flow controller 802 may be transmitted by wireless antenna 818, allowing for ease of use in the field. Properties, such as temperature, pressure, calculated flow rate, and rate of decay measurements may all be transmitted by the wireless antenna 818. Processes in the mass flow controller 802 may be initiated via signals received by the wireless controller 818. For example, a rate of decay measurement may be initiated by a signal received by the wireless antenna 818.

The communication interface 820 allows for data to be transmitted to and from the mass flow controller 802 over any communication protocol. For example, the calibrated volume input signal may be transmitted to the mass flow controller by the communication interface. Examples of communication protocols that may be implemented by the communication interface 820 include, but are not limited to DeviceNet, EtherCat, EtherNet, RS485, RS232, and Profibus. A user may set various settings through the communication interface 820. For example, the setpoint flow rate may be set by transmitting date through the communications interface 820.

In another example, an alarm threshold may be set through the communication interface 820. The alarm threshold may be any condition that sets off an alarm when the condition is satisfied. In one embodiment, the condition for an alarm threshold may be that the absolute value of a calibration parameter is greater than a set value. The absolute value of the calibration parameter would be an indication of working order for the mass flow controller 802. In one implementation, the mass flow controller 802 periodically calibrates itself and sets off an alarm through the communication interface 820 if the absolute value of the calibration parameter is greater than an alarm threshold. In various embodiments, an alarm threshold is set to detect a deviation of accuracy based on a rate of decay measurement. In one example, the mass flow controller 802 may be configured to automatically perform rate of decay measurements at a periodic time interval. The alarm condition may be met when the rate of decay measurement deviates from an expected result by a minimum threshold.

The shut-off valve 822 is a valve that can stop the flow of fluid through the main fluid flow path 804. The shut-off valve 822 may be various valve types including, but not limited to solenoid, piezo electric, and stepper motor. In one embodiment, the shut-off valve 822 is separate from the proportional valve 823. In various embodiments not shown in FIG. 8, the shut-off valve 822 also serves as the proportional valve 823 and is used to control the flow of fluid through mass flow controller 802.

The shut-off valve 822 is operated for rate of decay measurements. For a rate of decay measurement, the shut-off valve 822 begins in the open position and allows fluid to flow through the main fluid flow path 804. When a signal is given to begin a rate of decay measurement, the shut-off valve 822 is closed and data is collected from the one or more sensors 824 to determine the change in flow rate. A volume may be determined from a rate of decay measurement. The determined volume may be adjusted through a calibration parameter to match a calibrated volume input signal. The rate of decay measurement may also be used to measure “valve leak-by.” “Valve leak-by” is a measure of the amount of fluid that leaks through the shut-off valve 822 when it is closed. The control module computer 812 may be programmed to periodically measure “valve leak-by” by performing a rate of decay measurement. In one embodiment, an alarm threshold may be a set value of “valve leak-by.” If the “valve leak-by” is greater than the alarm threshold, the communication interface 820 may transmit an alarm signal to a user.

To minimize “valve leak-by” the shut-off valve 822 may have an elastomer between the seat and body components of the shut-off valve 822. The elastomer may be composed of various materials that exhibit viscous and elastic properties. In one embodiment, the elastomer is a corrosion resistant material such as PCTFE, PTFE, TEFLON, and NYLON. The elastomer, being elastic, forms a seal within the shut-off valve 822, thus minimizing “valve leak-by.” In one embodiment, the valve disc is made of an elastomer material. The valve disc, made of elastomer material, forms a seal at the valve seat when the shut-off valve 822 is closed. The elastomer material may be more efficacious at closing the shut-off valve 822 than a hard metal material because small imperfections in the elastomer material do not prevent it from forming a perfect seal. The shut-off valve 822 with the elastomer material may also operate for a long period of time because the elastomer material is corrosion resistant.

The one or more sensors 824 measure the physical properties of fluid in the main fluid flow path 804. The one or more sensors 824 may measure the pressure of the fluid, the temperature of the fluid, or both. In one embodiment, a sensor measures the flow rate by diverting the main fluid flow path 804 into a parallel laminar flow path. The flow rate through the laminar flow path may be measured without significantly changing the flow rate of the fluid in the main fluid flow path 804. The flow rate of fluid through the parallel laminar flow path is proportional to the flow rate of the fluid through the main fluid flow path 804. Therefore, the flow rate of the fluid through the mass flow controller 802 may be ascertained by measuring the flow rate of fluid through the laminar flow path. The calibration component 814 may be used to adjust measurements of the flow rate made by the one or more sensors 824 to match the metrology of customer tools in the field. By matching the metrology in the field, the one or more sensors 824 in the mass flow controller 802 may provide measurements that are consistent across multiple devices.

The proportional valve 823 may be adjusted to control the flow rate of fluid through the mass flow controller 802. The proportional valve 823 may be an orifice or the like that is adjustable. Opening the orifice of the proportional valve 823 may allow increased flow of fluid through the orifice and have the effect of increasing the flow rate of fluid through the mass flow controller 802. In one embodiment, the proportional valve 823 also serves as a shut-off valve 822. In an exemplary embodiment shown in FIG. 1, the proportional valve 823 is downstream of the shut-off valve 822.

The flow restrictor 826 is an orifice that blocks the flow of fluid through the main fluid flow path 804 to make the fluid flow choked. Under choked flow conditions, the flow rate is independent of the pressure downstream. Under unchoked conditions, the flow rate becomes unpredictable because the proportional valve 823 does not have absolute control over the flow rate.

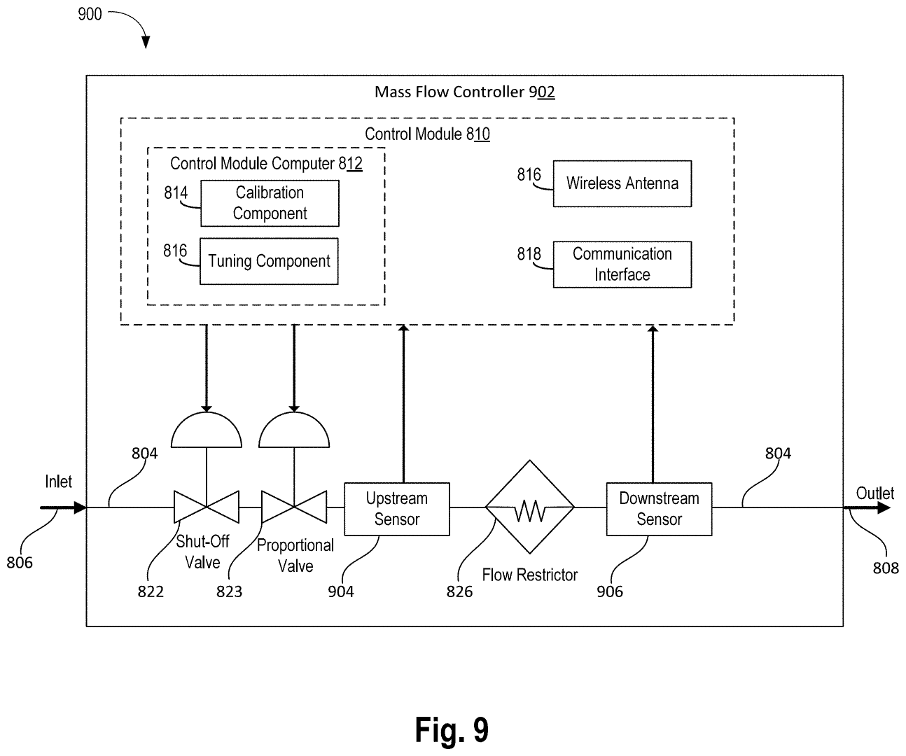

Referring to FIG. 9, FIG. 9 is a schematic 900 of a mass flow controller 902 illustrating the components that may be used in an embodiment of the disclosed subject matter. The mass flow controller 902 has a sensor on either side of the flow restrictor 824. An upstream sensor 904 is upstream of the flow restrictor 824 in the main fluid flow path 804. A downstream sensor 906 is downstream of the flow restrictor 824 in the main fluid flow path. The upstream sensor 904 may measure any property of the fluid including, but not limited to pressure, temperature, or both pressure and temperature.

A ratio of pressure or temperature, measured at the upstream sensor 904, to the pressure or temperature, measured by the downstream sensor 906, may be calculated by the control module computer 812. The ratio, at which flow though the flow restrictor transitions between choked flow and unchoked flow, is the critical ratio. The mass flow controller 902 may not be able to precisely maintain a flow rate under unchoked flow conditions. Likewise, the calculated flow rate may not be accurate under unchoked flow conditions. The critical ratio may be programmed into the control module computer 812 through the communication interface 820. The critical ratio is different based on the composition of fluid that is passing through the mass flow controller 902, so a different critical ratio may be programmed into the control module computer 812 for each composition of gas.

Because the calculated flow rate may be inaccurate in unchoked conditions, the critical ratio may be determined by finding the ratio at which the calculated flow rate is inaccurate. A rate of decay measurement may be implemented at various flow rates to determine the critical ratio and the accuracy of the calculated flow rate. The mass flow controller may also receive a calibrated input signal and perform a rate of decay measurement, just like it does to calibrate, to determine the accuracy of the calculated flow rate at various ratios. Once the critical ratio is determined for a composition of gas, the critical ratio may be saved into the memory of the control module computer 812 for that composition of gas.

The control module computer 812 may be configured to set off an alarm when the critical ratio is passed. The alarm threshold may be configured by the user over various communication protocols such as DeviceNet, EtherCat, EtherNet, RS485, RS232, Profibus, or any digital communication method. In one embodiment, the alarm threshold is set automatically by the control module computer 812. Rate of decay measurements are performed at various flow rates to determine the flow rate at which the calculated flow rate is inaccurate. The control module computer 812 records the ratio at which the calculated flow rate becomes inaccurate and automatically configures an alarm. The alarm activates when the currently measured ratio of a property of the upstream sensor to a property of the downstream sensor passes the critical ratio.

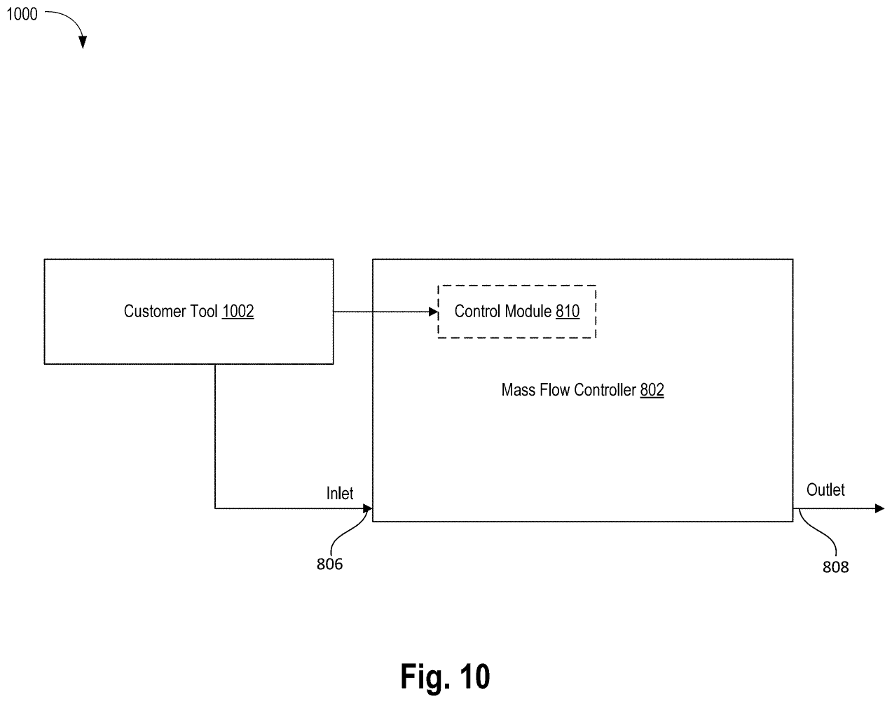

Referring to FIG. 10, FIG. 10 is a schematic 1000 of a mass flow controller 802 attached to a customer tool 1002. The customer tool sends the control module 810 a calibrated volume input signal. The customer tool 1002 concurrently delivers a volume of fluid to the inlet 806 of the mass flow controller 802. The customer tool 1002 sends a signal to the control module 810 when the customer tool 1002 has completed delivery of the volume of fluid to the intel 806.

When the signal is received, the control module 810 sends a signal to close the shut-off valve 822 and begin a rate of decay measurement. Data from the one or more sensors 824 is collected during the rate of decay measurement. The rate of decay measurement is complete when the one or more sensors 824 detect that the flow rate is zero. Based on data collected from the one or more sensors 824, the control module computer 812 calculates a volume of the fluid that was delivered by the customer tool 1002. The calibration component 814 sets a calibration parameter to match the calculated volume to the calibrated volume input signal. The calibration parameter will perform the same adjustment on subsequent measurements. The subsequent measurements should agree with the measurements of the customer tool 1002.

The customer tool 1002 may send a calibrated volume input signal at multiple flow rates across the spectrum of the mass flow controller 802. For example the customer tool 1002 may send a calibrated volume input signal at a 100% fully open proportional valve 823 and at incrementally more closed proportional valve 823 positions all the way down to a 0.25% open proportional valve 823. Every time the customer tool 1002 sends a calibrated volume input signal, the customer tool also delivers a volume a fluid to the inlet 806 of the mass flow controller 802. When the rate of decay measure is performed, the calibration component 814 may update the calibration parameter across the spectrum of the mass flow controller 802, such that the measurements of the mass flow controller 802 match the measurements of the customer tool 1002.

The customer tool 1002 may send the control module 810 thresholds for response overshoot and overshoot flow requirements. The thresholds for response overshoot and overshoot flow requirements are used by the tuning component 816 to update the tuning parameter, which determines how the proportional valve 823 is adjusted to match the calculated flow rate to the setpoint flow rate. Like the calibration parameter, the tuning parameter may be configured across the spectrum of the mass flow controller 802. A user may use the customer tool 1002 in the field to set the tuning parameter based on the needs of the user.

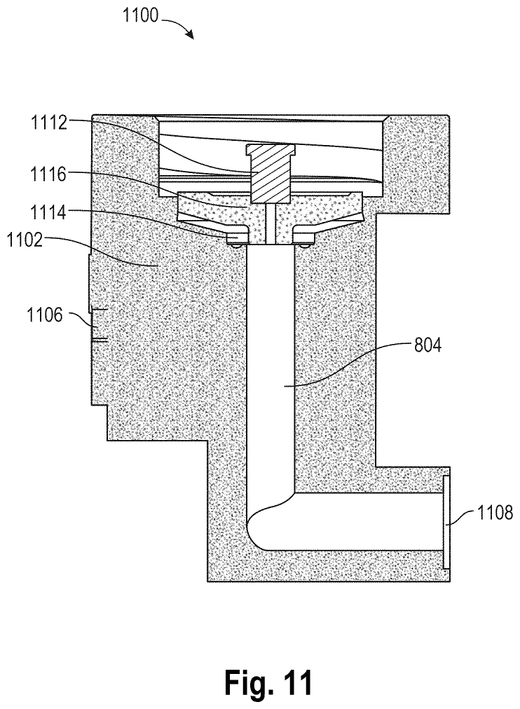

Referring to FIG. 11, FIG. 11 is a cross-sectional view 1100 of the bottom portion of the mass flow controller 802. The mass flow controller 802 includes a valve body 1102, an inlet 1106 and an outlet 1108. The mass flow controller 802 may receive user input through the communication interface 820 or wireless antenna 818. Likewise, the mass flow controller 802 may send data to a user through the communication interface 820 or the wireless antenna 818.

The main fluid flow path 804 begins at the inlet 1106 and exits at the outlet 1108. A setpoint flow rate is set by the user. The calculated flow rate is determined from data that is collected by the one or more sensors 824.

The tuning parameter of the tuning component 816 determines how the proportional valve 823 is adjusted to match the calculated flow rate to the setpoint flow rate. A user may set the tuning parameter at various points on the spectrum of the mass flow controller 802 in the field. A signal is sent to operate the proportional valve 823 based on the tuning parameter.

The valve body 1102 provides the structure of the proportional valve 823. The inlet 1106 is an opening by which fluid may enter the main fluid flow path 804 of the mass flow controller 802. The valve disc 1112 and valve seal 1114 may be made of a corrosion resistant elastomer material such as PCTFE, PTFE, TEFLON, or NYLON. The valve disc 1112 forms a seal with the valve seat 1116 when the proportional valve 823 is closed. The valve seal 1114 prevents fluid from leaking through the proportional valve 823 when the proportional valve 823 is closed.

When the proportional valve 823 is open, fluid may pass through the mass flow controller 802 and out through the outlet 1108. The valve disc 1112, made out of elastomer, forms a better seal with the valve seat 1114 than harder materials. The elastomer, which is elastic, may shape itself to imperfections in the valve seat 1114. The corrosion resistant properties of the valve disc 1112 allow the valve disc 1112 to operate for a longer period of time than other elastic materials.

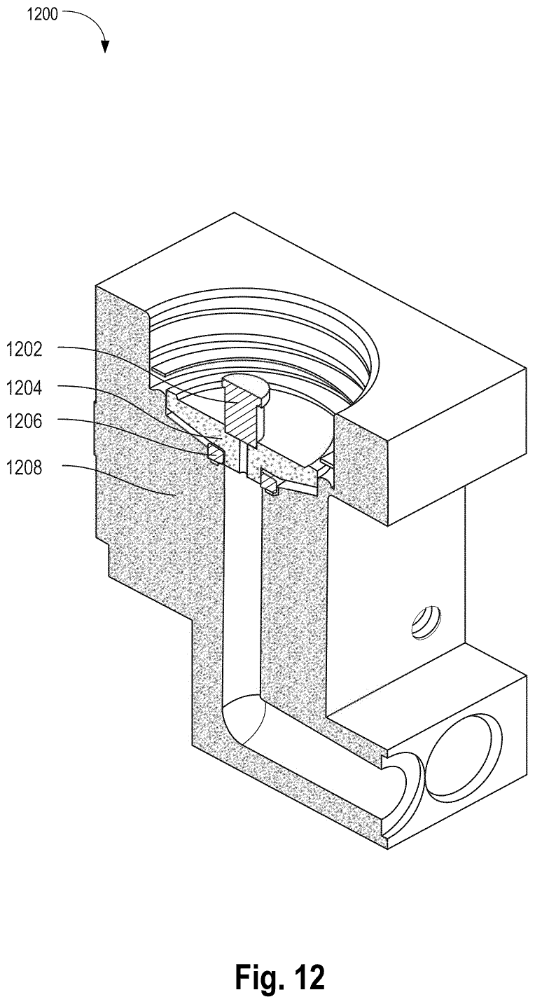

Referring to FIG. 12, FIG. 12 is a cross-sectional perspective view 1200 of the bottom portion of the mass flow controller 802. A valve disc 1202 fits over a valve seat 1204 to seal the proportional valve 823. The valve disc 1202 may be lifted off the valve seat 1204 by various means, such as with an actuator, to open the proportional valve 823. Like the valve disc 1202, a valve seal 1206 in between the valve seat 1204 and a valve body 1208 may also be made of a corrosion resistant elastomer material such as PCTFE, PTFE, TEFLON, or NYLON.

The corrosion resistant elastomer material of the valve seal 1206 and valve disc 1202 may prevent fluid from passing through imperfections in the proportional valve 823. By preventing fluid from passing through imperfections, the valve seal 1206 and valve disc 1202 help prevent “valve leak-by.” “Valve leak-by” may interfere with the calibration and tuning parameters. A test for “valve leak-by” may be conducted by performing a rate of decay measurement. The rate of decay measurement entails closing the shut-off valve 822 and measuring the flow rate with the one or more sensors 824.

A user may measure “valve leak-by” by sending a command to the mass flow controller 802. The command to measure “valve-leak-by” may be received by the wireless antenna 818 or the communication interface 820. Likewise, the result of the rate of decay measurement for “valve leak-by” may be sent to a user via the wireless antenna 818 or communication interface 820. The control module computer 812 may be configured to periodically test for “valve leak-by.” Based on the results of the periodic “valve leak-by test,” an alarm may be configured to alert a user if the result is beyond a threshold. Like other alarm threshold settings, the “valve leak-by” alarm setting may be configured over various communication protocols such as DeviceNet, EtherCat, EtherNet, RS485, RS232, and Profibus.

The valve body 1208 may provide the structure for the main fluid flow path 804. The valve seal 1206 prevents the leaking of fluid through the seam that runs between a valve seat 1204 and the valve body 1208. The valve disc 1202 may cover the valve seat 1204 and prevent fluid from flowing through the mass flow controller 802 when the proportional valve 823 is closed.

In various embodiments, the valve seal 1206 and valve disc 1202 may be shaped differently to function in various types of valves. The proportional valve 823 may be various valve types such as solenoid, piezo electric, stepper motor, and other valve types. The elastomer material for the valve seal 1206 and valve disc 1202 may improve the function for the various types of valves that the proportional valve 823 may be.

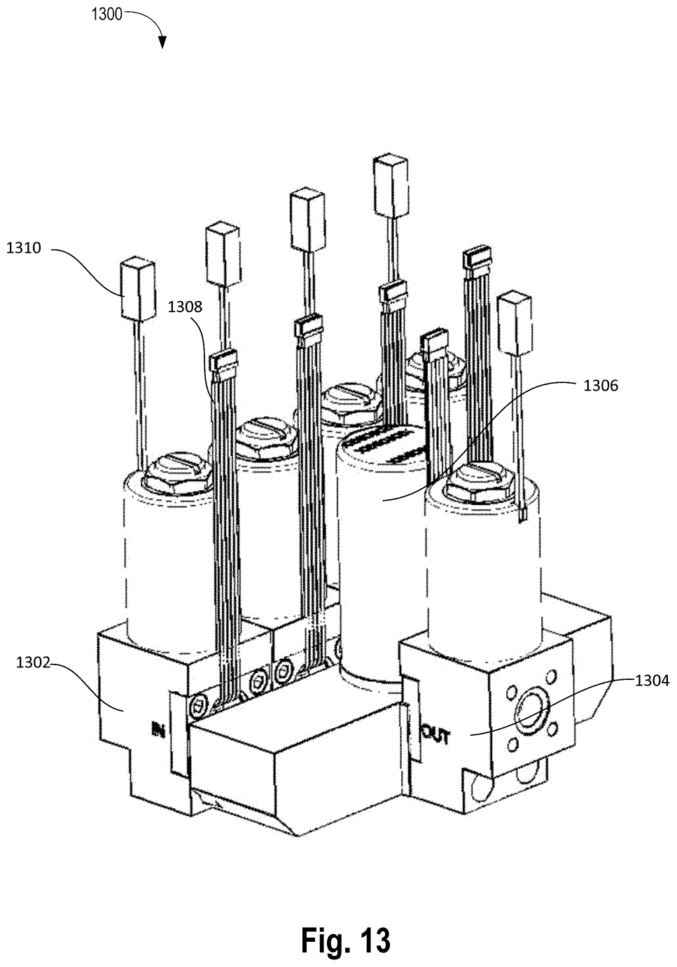

Referring to FIG. 13, FIG. 13 is a perspective view 1300 of a multitude of mass flow controllers 802 that are connected by a manifold. Mass flow controller 1302 is one of five mass flow controllers 802 shown in FIG. 13. As shown in FIG. 13, each mass flow controller 802 may have a communication interface connection 1308 and a power connection 1310. The communication interface connection 1308 may facilitate the transmission of data between a user and the mass flow controller 802. The communication interface connection 1308 may be connected to a customer tool 1002 that transmits data to match the customer metrology to the metrology of the mass flow controllers 802.

In one embodiment the mass flow controller 1302 and the three mass flow controllers 802 in line with mass flow controller 1302 accept fluid through an inlet and direct the fluid into a reference volume chamber 1306 where the fluid is mixed. The mixed fluid is directed from the reference volume chamber 1306 to mass flow controller 1304 where the flow rate of the mixed fluid is controlled as it is directed to the outlet 808 of mass flow controller 1304. Each of the mass flow controllers 802 may be separately calibrated using a customer tool 1002. In various embodiments, only one mass flow controller 802 is calibrated using a customer tool 1002 to match the metrology of the customer tool 1002 to the mass flow controller 802. The mass flow controller 802 that was calibrated is then used to calibrate the other mass flow controllers 802 that receive the same gas composition by sending the mass flow controllers a calibrated input signal and directing a volume of gas that coincides with the calibrated input signal to the other mass flow controllers 802. However, the other mass flow controllers 802 that receive a different gas composition would have to be separately calibrated by the customer tool 1002 because the calibration is dependent on the composition of gas.

Similarly, a customer tool 1002 may be used to send the tuning parameters to each of the mass flow controllers 802. In various embodiments, one mass flow controller 802 is tuned by the customer tool 1002. The mass flow controller 802 that was tuned by the customer tool 1002 may be used to set the tuning parameters of the other mass flow controllers 802 that receive the same composition of gas. By using the mass flow controllers 802 to calibrate and tune one another, time and effort may be saved.

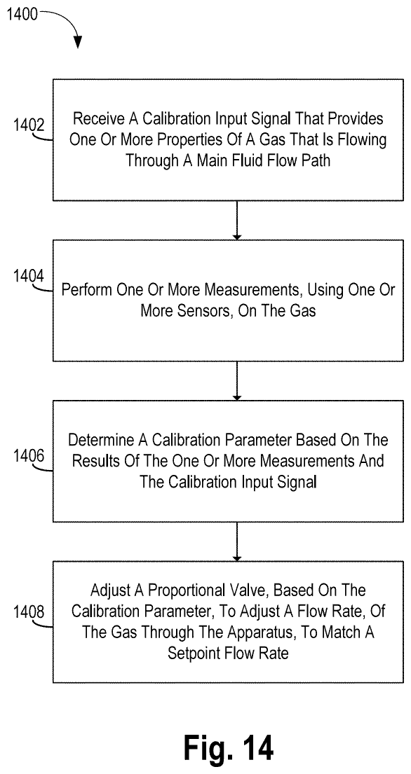

Referring to FIG. 14, FIG. 14 is a flow diagram 1400 for a process of matching the metrology of the mass flow controller 802 to the metrology of the customer tool 1002. At step 1402, the mass flow controller 802 may receive a calibration input signal that provides one or more properties of a gas that is flowing through a main fluid flow path 804. The calibration input signal may be received by the customer tool 1002. At the same time, the customer tool 1002 may direct a volume of the gas to the mass flow controller 802, the goal of which is for the mass flow controller 802 to match the volume of the gas to the calibration input signal.

At step 1404, the mass flow controller 802 may perform one or more measurements, using one or more sensors, on the gas. The one of more sensors 824 of the mass flow controller 802 perform the measurements on the gas to determine the volume of the gas. The measurements may be various measurements that can be used to determine the volume of the gas. In various embodiments, the one or more sensors 824 measure the temperature of the gas as the gas is directed through a parallel laminar tube that is heated. The temperature measurement may be used to determine the flow rate of gas through the laminar tube, which in turn is used to determine the flow rate of the gas moving through the main fluid flow path 804.

At step 1406, the mass flow controller 802 may determine a calibration parameter based on the results of the one or more measurements and the calibration input signal. The calibration parameter matches the measurement of the gas to a measurement in the calibration input signal. In one embodiment, the calibration parameter is a number that, when multiplied by the measurement, produces a measurement equal to a measurement transmitted by the calibration input signal. In various embodiments, the calibration parameter may be a linear regression that is based on multiple calibration input signals at different flow rates.

At step 1408, the mass flow controller may adjust a proportional valve 823, based on the calibration parameter, to adjust a flow rate of the gas through the apparatus, to match a setpoint flow rate. The mass flow controller 802 may determine a flow rate of the gas based on measurements from the one or more sensors 824. The flow rate will be operated on by the calibration parameter to match the determined flow rate to a metrology based on the calibration input signal. The proportional valve 823 may be adjusted based on the difference between the setpoint flow rate and the determined flow rate based on the calibration. In one embodiment, the proportional valve 823 is adjusted based on a P,I,D calculation.

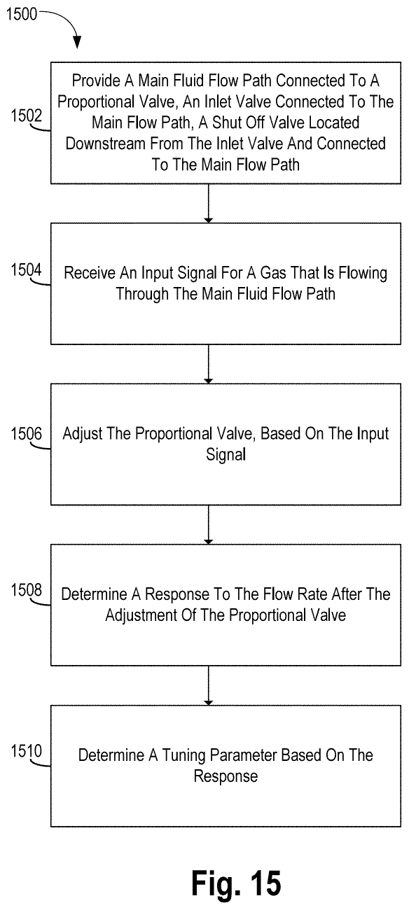

Referring to FIG. 15, FIG. 15 is a flow diagram 1500 for a process of tuning the mass flow controller 802 in situ. The tuning process may need to be performed for every composition of gas that flows through the mass flow controller 802. At step 1502, the mass flow controller 802 may provide a main fluid flow path 804 connected to a proportional valve 823, an inlet 106 connected to the main flow path 804, a shut-off valve 822 located downstream from the inlet 806 and connected to the main flow path 804. Gas may enter the mass flow controller 802 through the inlet 806 where the gas is directed through the main fluid flow path 804 through the shut-off valve 822 and proportional valve 823.

At step 1504, the mass flow controller 802 may receive an input signal for a gas that is flowing through the main fluid flow path 804. The input signal may be received from a customer tool 302 that is connected to the communication interface 820 of the mass flow controller 802. The input signal may be a data point that causes the mass flow controller 802 to respond. In one embodiment, the input signal is a setpoint flow rate.

At step 1506, the mass flow controller 802 may adjust the proportional valve 823, based on the input signal. In one embodiment, the proportional valve 823 is adjusted based on the difference between a setpoint flow rate that was set by the input signal and a calculated flow rate. In one example of the proportional valve 823 being adjusted based on the difference in flow rates, an adjustment is determined based on a PID control mechanism. Under the PID mechanism, the sum of the proportion of the difference, the integral of the difference over time, and the gradient of the difference over a period of time are added to determine the adjustment of the proportional valve 823. A separate parameter may be set for each of the P, I, and D terms. The PID terms may be multiplied by their respective parameters.

At step 1508, the mass flow controller 802 may determine a response to the flow rate after the adjustment of the proportional valve 823. The ideal response of the flow rate is for the flow rate to match the setpoint flow rate in a minimum amount of time. However, the flow rate may overshoot the setpoint flow rate if the proportional valve 823 adjusts too aggressively to match the setpoint flow rate. The overshoot may occur indefinitely in an oscillating pattern.

At step 1510, the mass flow controller 802 may determine a tuning parameter based on the response. In one embodiment, the tuning parameter is a set of PID parameters. In one example of setting PID parameters, a Ziegler-Nichols method is used. Under the Ziegler-Nichols method, The I and D parameters are set to zero. The P parameter is increased until the response starts to oscillate. The PID parameters are then determined based on the value of the P parameter that caused the oscillation and the period of the oscillation.

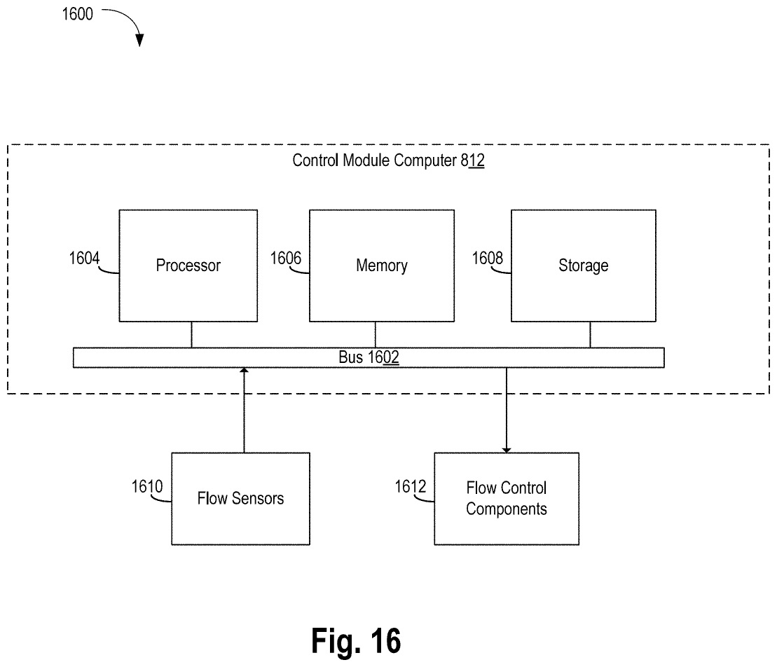

Referring to FIG. 16, FIG. 16 is a block diagram of a computer system 1600 that may be implemented in the various embodiments of the control module computer 812. The computer system 1600 includes a bus 1602, a processor 1604, a memory 1606, a storage 1608, one or more flow sensors 1610, and flow control components 1612. The bus 1602 connects the various components of the computer system 1600 to one another. The bus 1602 may include various means of connecting the various components. The bus 1602 may connect the various components of a computer system 1600 by a serial link or a parallel link. The bus 1602 may employ different types of connections based on the components of the computer system 1600 that the bus 1602 is linking. For instance, the bus 1602 may employ a slower connection that links the flow control components 1612 to the memory 1606 than the faster connection of the processor 1604 to the memory 1606.

The processor 1604 performs computations based on data that is received via the bus 1602. The processor 1604 may be connected to the memory 1606 by a very fast bus 1602 connection to facilitate fast computation. The processor may be various types of general purpose processor including, but not limited to a central processing unit (“CPU”), a graphics processing unit (“GPU”), a complex programmable logic device (“CPLD”), a field programmable gate array (“FPGA”), or an application-specific integrated circuit (“ASIC”). The processor 1604 performs the various calculations that include, but are not limited to determining the flow rate, rate of decay measurement, “valve leak-by” measurement, calibration parameter, calibration adjustment, tuning parameter, tuning adjustment, proportional valve 823 adjustment, and shut-off valve 822 state. The calculations that are performed by the processor 1604 may be transmitted to the memory 1606, where the results of the calculations of the processor 1604 are carried out.

The memory 1606 stores the instructions that are carried out by the various components of the computer system 1600. The memory 1606 transmits computations to the processor 1604 and receives the results of computations from the processor 1604. The memory 1606 may be various types of main memory including, but not limited to random access memory (“RAM”) and read only memory (“ROM”). The results of computations from the processor 1604 that are received by the memory 1606 may be carried out by the memory 1606. The memory 1606 may transmit signals through the bus 1602 to effect processes in the various components of the computer system 1600. The memory 1606 may transmit data to the storage 1608 for long term keeping. A user may transmit data to the storage 1608 through the memory 1606 over any communication protocol such as DeviceNet, EtherCat, EtherNet, RS485, RS232, and Profibus.

The storage 1608 can store, receive and transmit data via the bus 1602. Typically, the storage 1608 receives and transmits data only to the memory 1606. The storage 1608 may be various types of the computer storage that can retain data when the computer system 1600 is unpowered. Types of storage 1608 that can be used in the computer system 1600 include, but are not limited to, magnetic disk memory, optical disk memory, and flash memory. The storage 1608 may store various settings of the mass flow controller 802 including, but not limited to the alarm thresholds, calibration parameter, and tuning parameter. A different alarm threshold, calibration parameter, and tuning parameter may be stored for every different type of gas or composition of gas that may flow through the mass flow controller 802. The storage 1608 may store data that is collected from the measurements of the one or more sensors 824. Over time, long term data may be used to show the degradation, if any, in the one or more sensors 824 or other components of the mass flow controller 802.

The computer system 1600 accepts measurements from one or more flow sensors 1610. The one or more flow sensors 1610 may measure any property of a gas or fluid that flows through the main fluid flow path 804. The measured properties of the gas or fluid may be transmitted to the memory 1606 through the bus 1602. The memory 1606, together with the processor 1604, may determine a flow rate of the gas or fluid based on the measured properties. In one embodiment, the amount of gas may be determined by the change in temperature as the gas is diverted through a parallel laminar tube in the sensor. The change in temperature is measured by the one or more flow sensors 1610, which is transmitted through the bus 1602 to the memory 1606. The memory 1606 sends computations to the processor 1604 to determine the flow rate of gas. The calibration parameter may be a part of the final calculation of the flow rate of gas. The calibration parameter adjusts of flow rate calculation to match a flow rate of a customer tool 302. The calibration parameter may be stored in the storage 1608.

The computer system 1600 sends signals to one or more flow control components 1612. The flow control components 1612, include, but are not limited to the shut-off valve 822 and the proportional valve 823. The shut-off valve 822 may be in an open or closed state. In the open state, the shut-off valve 822 allows a gas or fluid to flow through the mass flow controller 802. In the closed state, the shut-off valve 822 prevents gas or fluid from entering the mass flow controller 802. The gas or fluid already in the mass flow controller 802 may leave through the outlet 808. When a rate of decay measurement is made, a signal is sent to close the shut-off valve 822 while the one or more flow sensors 1610 collect data as the fluid or gas leaves the mass flow controller 802.

The proportional valve 823 may receive signals from the computer system 1600 to adjust an opening in the proportional valve 823 that restricts the flow of gas or fluid through the proportional valve 823. In one embodiment, the proportional valve 823 may be instructed to open based on various configuration points across the spectrum of the mass flow controller 802. For example, the proportional valve 823 may be instructed to become fully 100% open while data is collected from the one or more flow sensors 1610 for one configuration point. The proportional valve 823 may be instructed to open to various other configuration points from as low as 0.25% open while data is collected from the one or more flow sensors 1610. The data that is collected from the one or more flow sensors 1610 for the configuration points may be used to create a calibration parameter.

The tuning parameter dictates how the proportional valve 823 is adjusted to match a calculated flow rate to a setpoint flow rate. The tuning parameter may be set by a customer tool 302. The computer system may receive instructions from the customer tool 1002 to send signals to the proportional valve 823 to adjust the proportional valve 823 to various configuration points. The flow rate at the various configuration points is measured by the one or more flow sensors 1610. The data is transmitted through the bus 1602 to the memory 1606 where the data is processed into a flow rate. The flow rate is sent to the customer tool 1002, which determines a tuning parameter.

Many variations may be made to the embodiments described herein. All variations are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

1. A method for calibrating a mass flow control apparatus, the method comprising:
receiving a calibration input signal that provides one or more properties of a gas that is flowing through a main fluid flow path;
performing one or more measurements, using one or more sensors, on the gas;
determining a calibration parameter based on the results of the one or more measurements and the calibration input signal;
adjusting a proportional valve, based on the calibration parameter, to adjust a flow rate, of the gas through the apparatus, to match a setpoint flow rate.

2. The method of claim 1, wherein the one or more measurements are one or more rate of decay measurements.

3. The method of claim 1, further comprising determining a measured volume based on the results of the one or more rate of decay measurements;
wherein the calibration input signal provides an actual volume of the gas; and
wherein the calibration parameter matches the measured volume to the actual volume.

4. The method of claim 3, further comprising:
detecting a deviation of accuracy based on the calibration parameter;
setting off an alarm to alert a user of the deviation; and
transmitting the alarm over a communication protocol.

5. The method of claim 1, wherein the shut off valve comprises an elastomer located between a shut off valve seat and shut off valve body components.

6. The method of claim 5, further comprising:
performing a subsequent rate of decay measurement, responsive to receiving a command, based on the calibration parameter; and
determining a leak-by value based on the subsequent rate of decay measurement.

7. The method of claim 1, wherein the setpoint flow rate is received by a wireless antenna.

8. A mass flow control apparatus, the apparatus comprising:
a main fluid flow path connected to a proportional valve;
at least one sensor that measures a property of a gas in the flow path downstream to a flow restrictor;
a shut off valve with a shut off valve seat and shut off valve body components, located downstream from an inlet valve and connected to the main fluid flow path;
a control module configured to receive a calibration input for a gas and calculate a rate of decay from a signal from the at least one sensor when the inlet valve is closed;
the control module is further configured to calculate a calibration parameter based on the rate of decay;
the control module is further configured to receive a setpoint flow rate; and
the control module is further configured to adjust the proportional valve, based on the calibration parameter, to adjust a flow rate, of the gas through the apparatus, to match the setpoint flow rate.

9. The mass flow control apparatus of claim 8, wherein the calibration input is an actual volume of the gas; and
wherein the calibration parameter matches a measured volume, based on the rate of decay, to the actual volume of the gas.

10. The mass flow control apparatus of claim 8, wherein the calibration input is one or more values for actual flow performance;
wherein each of the one or more values for actual flow performance is given for a configuration point that is on the flow spectrum for the apparatus; and
wherein the calibration parameter determines a measured flow rate, based on the rate of decay, and matches the measured flow rate to each of the one or more values for actual flow performance.

11. The mass flow control apparatus of claim 10, wherein the control module is further configured to detect a deviation of accuracy based on the calibration parameter and set off an alarm to alert the user of the deviation; and
wherein the alarm is further configured to transmit an alarm signal over a communication protocol.

12. The mass flow control apparatus of claim 8, further comprising an elastomer located between the shut off valve seat and shut off valve body components.

13. The mass flow control apparatus of claim 12, wherein the elastomer is a corrosion resistant material selected from the group consisting of PCTFE, PTEE, TEFLON, or NYLON.

14. The mass flow control apparatus of claim 12, wherein the control module is configured to calculate a leak-by value based on the rate of decay.

15. The mass flow control apparatus of claim 8, further comprising a wireless antenna that can receive signals and transmit signals.

16. A method for tuning a mass flow control apparatus, the method comprising:
providing a main fluid flow path connected to a proportional valve, an inlet valve connected to the main fluid flow path, a shut off valve located downstream from the inlet valve and connected to the main fluid flow path;
receiving an input signal for a gas that is flowing through the main fluid flow path;
adjusting the proportional valve, based on the input signal.
determining a response to the flow rate after the adjustment of the proportional valve; and
determining a tuning parameter based on the response.

17. The method of claim 16, wherein the input signal is received at one or more configuration points on the flow spectrum of the mass flow control apparatus.

18. The method of claim 16, wherein the input signal is received by a wireless antenna.

19. The method of claim 16, wherein the shut off valve comprises an elastomer material at the seal of a valve seat and a valve body component.

20. The method of claim 19, further comprising:
performing a rate of decay measurement, responsive to receiving a command; and
determining a leak-by value based on the subsequent rate of decay measurement.
